(19) United States
(12) Patent Application Publication
(10) Pub. No.: US 2014/0279474 A1
(43) Pub. Date: Sep. 18, 2014

(54) MULTI-PURSE ONE CARD TRANSACTION APPARATUSES, METHODS AND SYSTEMS

(71) Applicant: Visa International Service Association, San Francisco, CA (US)

(72) Inventors: Steven Evans, Foster City, CA (US); Marla Bischoff, Foster City, CA (US); Andrew Carpenter, Foster City, CA (US)

(73) Assignee: Visa International Service Association, San Francisco, CA (US)

(21) Appl. No.: 14/207,144

(22) Filed: Mar. 12, 2014

Related U.S. Application Data
(60) Provisional application No. 61/778,258, filed on Mar. 12, 2013.

(51) Int. Cl. G06Q 20/34; G06Q 20/40; G06Q 20/36

(52) U.S. Cl. CPC G06Q 20/3572; G06Q 20/363; G06Q 20/342; G06Q 20/40
USPC 705/41

(57) ABSTRACT

The Multi-Purse One Card Transaction Apparatuses, Methods And Systems (“MPOC”) transform purchase item information inputs via MPOC components into account payment settlement outputs. In one implementation, the MPOC may obtain purchase item information and consumer digital wallet information at a merchant terminal; obtain consumer payment account usage rules based on the consumer digital wallet information; obtain purchase item category information from the purchase item information; determine that at least one purchase item qualifies for a consumer payment account based on the consumer payment account usage rules; generate a payment authorization request message in compliance with a transaction processing format; and send the generated payment authorization request message to a financial transaction processing server.

This application for letters patent discloses and describes various novel innovations and inventive aspects of MULTI-PURSE ONE CARD TRANSACTION technology (hereinafter “MPOC”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### CROSS REFERENCE TO RELATED APPLICATIONS

This application claims the benefit of, and priority to, U.S. Provisional Application No. 61/778,258 titled “MULTI-PURSE ONE CARD TRANSACTION APPARATUSES, METHODS AND SYSTEMS,” filed Mar. 12, 2013. The content of which is hereby incorporated by reference in its entirety.

### FIELD

The present innovations generally address apparatuses, methods, and systems for prepaid card transactions, and more particularly, include MULTI-PURSE ONE CARD TRANSACTION APPARATUSES, METHODS AND SYSTEMS (“MPOC”).

### BACKGROUND

A consumer desires to use a payment card to purchase items from a merchant. The consumer brings purchase items to a merchant point of sale (PoS) checkout terminal, which scans in purchase item information containing item price, item identifier and item quantity and provides a total amount for the consumer to pay. The consumer selects a payment card from the wallet, including a credit card and a debit card, and swipe the card at the merchant PoS terminal, and pay for the purchase items with the selected card. A restricted-use account is a financial account which is administered to restrict use of the account to purchase a qualified category of consumer goods and services. A flexible spending account (FSA) is a restricted-use account that is used exclusively for medical expenses and dependent care. A food stamp is also a restricted account that is used exclusively for qualified food products and grocery items (e.g., supplemental nutrition assistance program (SNAP). Other types of restricted-use accounts include temporary assistance for needy families (TANF) accounts, child support accounts, and electronic Women, Infants, and Children (eWIC) accounts. To use a FSA account, a user needs to collect receipts of payments eligible for FSA reimbursement, and send the receipts to a FSA administer program. Upon verifying eligibility of the expenses, the FSA administer program may return the user payment amount to the user, by an authorized transfer of funds from the user's FSA account to the user.

### BRIEF SUMMARY

In an example embodiment, the MULTI-PURSE ONE CARD TRANSACTION Apparatuses, Methods And Systems (“MPOC”) transform purchase item information inputs via MPOC components into account payment settlement outputs. In one implementation, the MPOC may obtain purchase item information and consumer digital wallet information at a merchant terminal; obtain consumer payment account usage rules based on the consumer digital wallet information; obtain purchase item category information from the purchase item information; determine that at least one purchase item qualifies for a consumer payment account based on the consumer payment account usage rules; generate a payment authorization request message in compliance with a transaction processing format; and send the generated payment authorization request message to a financial transaction processing server.

In another example, the example embodiments may receive a payment authorization request message associated with a purchase transaction, wherein the payment authorization request message is in compliance with a transaction processing format, process the payment authorization request message to obtain a value from a field that indicates an account type identified by user input and a unique identifier associated with a merchant, process the account type to determine which of a restricted-use account and a non-restricted use account has been identified as a source of funds for the payment transaction, in response to determining that the restricted-use account has been identified as the source of funds, process the unique identifier to determine that the merchant is an eligible provider of a good or service associated with the restricted-use account, in response to determining that the merchant is an eligible provider, identify routing information of an issuer processor associated with the restricted-use account, and routing, using the identified routing information, the payment authorization request message to the identified issuer processor for processing of the payment authorization request message.

Other systems, methods, features, and advantages of the present disclosure will be or will become apparent to one with skill in the art upon examination of the following figures and detailed description. All such additional systems, methods, features, and advantages are included within this description, are within the scope of the disclosure, and are protected by the accompanying claims. Accordingly, the present disclosure is not restricted except in light of the attached claims and their equivalents.

### BRIEF DESCRIPTION OF THE DRAWINGS

The accompanying appendices, drawings, figures, images, etc. illustrate various example, non-limiting, inventive aspects, embodiments, and features (“e.g.,” or “example(s)”) in accordance with the present disclosure:

FIGS. 1A, 1B, 1C, 1D provide block diagrams illustrating various scenarios of user engaging a multi-account card/wallet to conduct a purchase transaction within embodiments of the MPOC;

FIG. 2A provides a data flow diagram illustrating data flows between MPOC server and its affiliated entities for a smart merchant PoS checkout within embodiments of the MPOC;

FIGS. 2B, 2C provide data flow diagrams illustrating data flows between MPOC server and its affiliated entities for mobile wallet snap purchase bill payment within embodiments of the MPOC;

FIGS. 3A, 3B provide logic flows illustrating work flows for a smart merchant PoS checkout within embodiments of the MPOC;

FIGS. 3C, 3D,3E provide logic flows illustrating work flows for mobile wallet snap purchase bill payment within embodiments of the MPOC;

FIG. 4A provides a data flow diagram illustrating consumer account enrollment and account usage rule configuration within embodiments of the MPOC;

FIG. 4B provides a logic flow diagram illustrating consumer account enrollment and account usage rule configuration within embodiments of the MPOC;

FIGS. 5A, 5B, 5C, 5D provide logic flow diagrams and user interface (UI) diagrams illustrating account determination and recommendation within embodiments of the MPOC; and

FIG. 6 shows a block diagram illustrating example aspects of an MPOC controller.

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

The MULTI-PURSE ONE CARD TRANSACTION technology (hereinafter “MPOC”) provides a payment platform which processes a multi-purse consumer vehicle for both restricted-use accounts and non-restricted-use accounts. For example, the multi-purse consumer vehicle may comprise a prepaid card, an electronic mobile wallet, and/or the like, which stores information with regard to multiple consumer accounts.

The multi-purse consumer vehicle may store a common account number associated with some or all of a customer's restricted-use accounts and non-restricted-use accounts. When making a purchase from a merchant, the customer may input information used to create a processing code that specifies what type of account is to be the source of funds for a purchase transaction. A payment transaction authorization request message may be generated that includes a unique identifier of the merchant, the processing code, the common account number, and one or more codes for each product and/or service to be purchased. Because the same account number is used for multiple accounts, intelligence is required to route a payment authorization request message to the appropriate issuer processor for approval of the purchase transaction.

The combination of the unique identifier and the processing code may be used for routing the authorization request message to the appropriate issuer for approval. For example, the example embodiments may create the processing code based on the type of account a customer has indicated to use to complete the purchase transaction. Additionally, the merchant may register with an account issuer processor to become an eligible provider of a product and/or service under a program associated with a restricted-use account, and the account issuer processor may provide the merchant with the unique identifier. The merchant may present the unique identifier each time the merchant requests to debit a restricted-use account. When a particular combination of the processing code and unique identifier are presented, the example embodiments may presume that the customer accurately identified the appropriate restricted-use account and may confirm that the merchant is an eligible provider of goods and/or services for that type of restricted-use account.

If determined to be an eligible provider, the example embodiments may retrieve routing information for the associated restricted-use issuer processor for routing of the payment authorization request message thereto. For example, there may be multiple issuer processors (e.g., one for SNAP accounts, one for TANF accounts, one for FSA accounts, etc.), and the example embodiments may retrieve the routing information for a particular one of the issuer processors. Subsequent to receiving the payment authorization request message, the restricted-use issuer processor may determine whether to approve the transaction based on whether the restricted-use account has sufficient funds and whether the products/services are appropriate for purchase using the restricted-use account. Based on these determinations, the restricted-use issuer may then fully approve, partially approve, or decline the authorization request message. Denial may occur, for example, if the customer selected the incorrect restricted-use account, has insufficient funds, and/or attempted to purchase unapproved goods or services. Thus, even though a common account number is assigned to each of the user's restricted-use and non-restricted accounts, the example embodiments intelligently direct the payment authorization request messages to the appropriate issuer processor for processing.

In one implementation, MPOC may facilitate a user to engage a restricted-use account for the cost of eligible items. A restricted-use account may be a financial account having funds that can only be used for payment of approved products (e.g., prescription drugs, vaccine, food, etc.) and/or services (e.g., healthcare treatment, physical examination, etc.). Examples of a restricted use account may comprise Flexible Savings Accounts (FSA), one or more Health Savings Accounts (HSA), Line of Credit (LOC), one or more health reimbursement accounts (HRA), one or more government insurance programs (i.e., Medicare or Medicaid), various private insurance—rules, a supplemental nutrition assistance program (SNAP) account, a temporary assistance for needy families (TANF) account, a child support account, and an electronic Women, Infants, and Children (eWIC) account, various other restricted use favored payment accounts such as employment benefit plans or employee pharmacy benefit plans, and income deduction rules, and/or the like. In other examples, the restricted-use account may comprise a food voucher, a food stamp, and/or the like. Within implementations, the approval process of payment with a restricted use account may be administered by a third party, such as, but not limited to FSA/HSA administrator, government unemployment program administrator, and/or the like.

In one implementation, the MPOC may generate and process transaction authorization request messages including the processing code in an existing field and the unique identifier associated with the merchant that, in combination, are used by a card payment network to determine how to route a transaction, e.g., whether the transaction involves any restricted-use accounts, etc., to the appropriate issuer for authorization of the transaction. The unique identifier may be known to the issuer processor and a merchant that allows the issuer processor to identify the correct purse/account from which to debit funds and to authenticate merchant eligibility to access funds in the prepaid account for transactions restricted to approved merchants.

For example, the MPOC processing platform may facilitate payment with healthcare restricted-use accounts (e.g., FSA, HSA, etc.) when a user/patient visits a healthcare provider. In one embodiment, a user may operate a payment device (e.g., a mobile wallet component instantiated on a smart phone, a prepaid card, a web-based application, etc.) for checkout at a merchant, wherein the mobile computing device is web enabled, and may receive a communication from a point of service (PoS) terminal. The communication may include a balance due bill of a healthcare provider for healthcare to a user. The web enabled mobile computing device may execute an application that derives an optimized payment of the balance due bill that substantially maximizes incentives and minimize penalties in paying the healthcare provider for the healthcare provided to the user. The optimized payment is transmitted from the web enabled mobile computing device to the PoS for further authorization processing of one or more currency amounts to be paid from respective accounts to satisfy the balance due bill.

Integration of an electronic wallet, a desktop application, a plug-in to existing applications, a standalone mobile application, a web based application, a smart prepaid card, and/or the like in payment with restricted-use account reduces the number of network transactions and messages that fulfill restricted-use account payment approval and procurement of eligible purchase items (e.g., a user and/or a merchant does not need to file additional application requests for restricted-use account payment/reimbursement, which may require voluminous paper work or manual information fill-in). In this way, with the reduction of network communications, the number of transactions that may be processed per day is increased, i.e., processing efficiency is improved.

### Multi-Purse Card Transaction (MPOC)

FIG. 1A provides a block diagram illustrating aspects of user usage of various accounts within embodiments of the MPOC. In one implementation, a consumer 101 may have various payment accounts associated with various payment cards. For example, the consumer 101 may possess accounts and payment cards such as a bank card 102a (e.g., a bank credit card, a debit card, a checking card, etc.), a restricted-use account card 102b (e.g., HSA, FSA, LOC, government food stamp, voucher, etc.), mileage or club membership card 102c (e.g., Starbucks, Continental, JetBlue, etc.), gift cards (e.g., Macy's, JCPenny, etc.), and/or the like.

In one implementation, when a consumer 101 proceeds to checkout for his/her purchase, e.g., at a PoS terminal of a merchant store, an online shopping checkout page, etc., the consumer 101 may need to select an account to pay for the his/her shopping cart. In one implementation, the consumer 101 may get confused to select an appropriate card for the purchase 102, e.g., when to apply a FSA account, when to apply a membership card, etc. In one implementation, the MPOC platform may provide a streamline process for the consumer 101 to instantiate his/her wallet at a PoS terminal 109, which may automatically select an account from the wallet 104.

FIG. 1B provides an exemplary block diagram illustrating MPOC payment at a participating merchant within embodiments of the MPOC. In one implementation, a consumer 102 may have in his/her shopping cart a list of mixed items including restricted-use account eligible items 117a and non-eligible items 117b. For example, a consumer 102 may shop at a supermarket, a pharmacy store, etc., to purchase pharmaceutical drugs (e.g., NyQuil cold medicine, Antibiotics, etc.) which are eligible for FSA/HSA usage, and various items (e.g., body wash, shampoo, etc.) that are not eligible for any restricted-use account.

In one implementation, a consumer 102 may engage a mobile wallet 103 to pay for the purchase at a PoS terminal 109 of the merchant. In one implementation, the mobile wallet 103 may provide a prompt alert 111 to the consumer via a mobile consumer interface, showing that part or all of the consumer's purchases are eligible for one or more restricted-use accounts that have been enrolled in the consumer's mobile wallet. For example, as shown in FIG. 1B, when the consumer has purchased pharmaceutical products such as “NyQuil” and “Penicillin,” the mobile wallet may notify the consumers that such drugs are eligible for FSA usage. In one implementation, if the consumer selects “Yes” to proceed with payment with FSA, the consumer may need to split the purchase to pay for the eligible items 117a in the shopping cart with his FSA account and submit an amount of the drugs. For example, the consumer may view a list of the FSA eligible items 113a, and a list of healthcare restricted-use accounts such as FSA, HSA, etc. If the consumer selects to pay with FSA, the consumer may view the remaining balance of the FSA account 112. Upon selecting to pay 113, the consumer may submit the transaction to pay with FSA account for the healthcare products 113a.

In one implementation, the consumer may be directed to another list of remaining items which are non-eligible for any restricted-use items 121b, e.g., see 113b. The consumer may then need to select another account (e.g., a regular bank account, etc.), such as a Visa credit card 116 for non-eligible items 117b in a separate transaction.

In one implementation, the MPOC alert may be originated at a PoS terminal 109, wherein the merchant may maintain a blacklist/whitelist of eligible product codes for various types of restricted-use accounts, and may send notifications to the wallet via Near Field Communication (NFC) protocol 115.

In another implementation, a consumer's electronic wallet may identify eligible items for a restricted-use account itself, e.g., the PoS terminal 109 may generate a bill and transmit bill information to the consumer's wallet via NFC 115. In further implementations, the PoS terminal 109 may generate a bill comprise a QR code, and the consumer may snap a photo of the generated QR code on the bill, which may facilitate the intelligent wallet to capture information of consumer purchased items.

In an alternative implementation, the consumer may operate a restricted-use prepaid card, and the PoS terminal may inform the consumer eligibility of the consumer's purchase to apply his/her restricted-use account.

In further implementations, the consumer's mobile wallet may intelligently recommend an account in the wallet for the instant payment. For example, the mobile wallet may detect the consumer's location at a healthcare provider 108 via its GPS component, and thus may recommend healthcare benefit accounts for consumer payment by highlighting the accounts “FSA” 111 and “HSA”. When the consumer selects the FSA account 111, the wallet may display an available balance 112 of the FSA account. The consumer may then tap on a “pay” button 113 of the mobile wallet to initiate a consumer payment transaction.

FIG. 1C provides an example showing consumer checkout with QR code capturing at a merchant PoS terminal within embodiments of the MPOC. In some implementations, a consumer, e.g., 121a-b, may wish to purchase products at a merchant store, e.g., 123a, or at a merchant website, e.g., 123b. For example, at a merchant store, the consumer may scan barcodes for a number of products, e.g., 122a, at a PoS terminal in the store, e.g., 123a, and then indicate that the consumer wishes to checkout the scanned items. In some implementations, the PoS terminal may generate a Quick Response (“OR”) code, e.g., 125a, including information on the scanned product items, as well as merchant information for processing the purchase transaction via a payment network. The consumer may capture an image of the QR code generated by the PoS terminal using a consumer device, such as a smartphone. For example, the consumer device may have executing on it an app for snapping the merchant-product QR code. The consumer device may utilize the information extracted from the QR code, along with information on a virtual wallet tied to the consumer device to initiate a purchase transaction. For example, the consumer device may utilize the product and merchant information extracted from the QR code, and financial payment information from the virtual wallet, to create a purchase transaction request, and submit the request to a payment network (e.g., credit card processing network).

In some implementations, the consumer device may utilize methods alternative to capture of a QR code to obtain information from the PoS terminal. For example, the PoS terminal may communicate the information required for submitting a purchase transaction request to a payment network to consumer device via Bluetooth™, Wi-Fi, SMS, text message, electronic mail, and/or other communication methods.

In some implementations, a consumer 121b may wish to checkout items stored in a virtual shopping cart on an online shopping website, e.g., 122b. For example, the consumer may be viewing the website using a secure display (e.g., that is part of a trusted computing device of the consumer). Upon indicating that the consumer wishes to checkout the items in the virtual shopping cart, the website may provide a QR code including information on the products in the virtual shopping cart and merchant information. For example, in the scenario where the consumer utilizes a secure display, the QR code may be displayed at a random position within the secure display for security purposes. The consumer may capture a snapshot of the displayed QR code, and utilize payment information from the virtual wallet associated with the consumer device to create a purchase transaction request for processing by the payment network. Upon completion of the purchase transaction, the payment network may provide a purchase receipt, e.g., 127a directly to the consumer device 126a, the PoS terminal in the store and/or the secure display (for the secure online shopping scenario) as confirmation of completion of transaction processing. Thus, in some implementations, the merchant may be shielded from obtaining personal and/or private information of the consumer while processing the purchase transaction, while ensuring integrity of the consumer's virtual wallet using a secure display for presenting the merchant-product QR code.

In various implementations, such payment processing may be utilized for a wide variety of transactions. For example, a consumer dining at a restaurant may obtain a bill including a QR pay code including detail on the dining charges included in the bill, and a merchant ID for the restaurant. The consumer may take a snapshot of the restaurant bill using the consumer's smartphone, and utilize the consumer's virtual wallet to pay for the restaurant bill, without revealing any financial or personal information about the consumer to the restaurant.

In an alternative implementation, when the receipt 127a comprise a FSA eligible item 127b (e.g., prescription drugs, etc.), the user device 126a may receive a MPOC alert 111 to notify user eligibility of the purchase item for FSA usage. For example, in one implementation, the MPOC alert 111 may be received prior to user engage in the final payment so that the user may elect to pay with FSA account.

FIG. 1D provides a block diagram illustrating aspects of consumer configured restricted use accounts within embodiments of the MPOC. In one implementation, in addition to restricted-use accounts discussed in FIG. 1A, e.g., healthcare restricted-use accounts, government benefits restricted-use accounts, etc., a consumer may configure restricted-use of one or more of his/her accounts enrolled in a MPOC wallet account. For example, as shown at FIG. 1D(1), a consumer 101 may configure usage restriction for his/her accounts, e.g., based on purchase products category, purchase amount, purchase frequency, and/or the like. In one implementation, the consumer 101 may specify any purchase amount greater than $1000.00 is going to be charged to a specific credit card 133. The MPOC server 120 may store such instruction for future use 134.

As shown in FIG. 1D, when the consumer 101 attempts to pay for a purchase greater than $1000.00 135, e.g., by instantiating his/her MPOC wallet, the MPOC server 120 may retrieve the consumer configured rules, and may automatically select the pre-configured “Visa 0964” account 136 for such usage.

In further implementations, the MPOC server 120 may analyze the consumer's card selection preferences based on purchase history. For example, if the consumer has repeatedly selected card “Visa 0964” for relatively large payment amounts (e.g., greater than $1000.00, etc.), the MPOC server may generate heuristics of the consumer's card selection preference and may automatically recommend “Visa 0964” for the next purchase over $1000.00.

FIGS. 2A-2B provides a data block diagram illustrating data flow between MPOC server, user, merchant and affiliated entities to substantiate an in-flight PoS checkout payment at a merchant within embodiments of the MPOC. Within various embodiments, as shown in FIGS. 2A-2B, one or more user(s) 202, MPOC server 220, MPOC database(s) 219, merchant(s) (PoS terminal(s)) 210, account issuer network 230, and/or the like are shown to interact via various communication networks 213 to facilitate the substantiation of a user purchase payment transaction. Each device, server, etc., described herein may include one or more processors (e.g., microprocessors) and be associated with one or more computer readable media storing computer-executable instructions that, when executed, causes the respective device, server, etc., to perform the functions described herein. Further, functions described as being performed by a single device, server, etc., may be distributed and performed by two or more devices, servers, etc.

Within various embodiments, the user (e.g., an individual consumer, etc.) 202 may include a wide variety of different communications devices and technologies within embodiments of MPOC operation. For example, in one embodiment, the patient 102 may operate devices such as, but not limited to, terminal computers, work stations, servers, cellular telephony handsets, smart phones (e.g., an Apple iPhone, a Google Android, a BlackBerry, etc.), PDAs, and/or the like.

In one embodiment, the MPOC server 220 may be equipped at a terminal computer, a mobile device, and/or or the like of the user 202. In another embodiment, the MPOC server 220 may be a remote server which is accessed by the user 202 via a communication network 113, such as, but not limited to local area network (LAN), in-house intranet, the Internet, and/or the like. In a further implementation, the MPOC merchant 210 may communicate with the user 202 via a PoS terminal, and/or be integrated with a user 202 at a computer terminal. For example, the user 202 may operate a mobile device as a self-checkout device, e.g., see barcode scanning checkout examples in FIG. 2C.

Within embodiments, a user 202 may shop with a merchant 210, which may be a physical store, an online shopping site, and/or the like. For example, the user 202 may walk in a physical merchant store and bring a shopping cart of purchase item to a PoS terminal, which may scan in the purchase item information 203. In another example, the user 202 may engage in online shopping by adding purchase items into a virtual shopping cart and transmit the purchase item information 203 to the shopping site server. In one implementation, the user may optionally provide wallet (and/or card) information 204 pertaining to user specified account usage rules depending on shopping item characteristics, e.g., restricted account usage, preferred account for large amount purchases, etc. For example, the user may engage an electronic wallet via NFC handshake at a merchant PoS terminal, or swipe a multi-account card, or associate a wallet account (e.g., Visa V.me, etc.) with an online purchase page, and/or the like. Example data structure of user specified usage rules are provided at 442b in FIG. 4A.

For example, in one implementation, when a user conducts an online purchase or operates the user device to scan physical items in-store, purchase information 203 including an item name, an item category information, etc., may be sent to the merchant server 210. For example, a user device may generate a Hypertext Transfer Protocol Secure (HTTPS) POST message to send purchase item information 203 (which may contain optional wallet information 204) in the form of data formatted according to the XML. Use of XML in the examples described herein does not preclude the use of other messaging formats. For instance, the Visa ISO 8583 messaging format may be used instead of, or in addition to, XML. Other messaging formats may also be used. Below is an example HTTP(S) POST message including an XML-formatted message of the purchase item information 203 for the merchant 210:

POST /PurchaseItem.php HTTP/1.1
Host: 216.15.51.74
Content-Type: Application/XML
Content-Length: 718
<?XML version = “1.0” encoding = “UTF-8”?>
<PurchaseItem>

<Time> 17:40:40 </Time>
<Date> 09-09-2015 </Date>
<gps>

<latitude> 42° 32.96 </latitude>
<longitude> 74° 11.92 </longtitude>

</gps>
...
<Item1>

<ItemCode> FOOD-9875 </ItemCode>
<Category> FOOD </Category>
<Sub-Category> Breakfast </Sub-Category>
</ItemName> Cereal </ItemName>
<Description> whole grain original 10 oz </Description>
<location>

...
<floor> 1^{st} floor </floor>
<Aisle> 12 </aisle>
<stack> 4 </stack>
<shelf> 2 </shelf>

</location>
...
<Quantity> 1 </Quantity>
<UnitPrice> 4.99 </UnitPrice>
<TotalAmt> 4.99 </TotalAmt>
...

</Item1>
<Item2>

<ItemCode> DRUG-23401 </ItemCode>
<Category> DRUG </Category>
<Sub-Category> Non-Prescription </Sub-Category>
</ItemName> NyQuil Cold Medicine </ItemName>
<Description> NyQuil Cold&Flu Liquid 80 mL </Description>
<location>

...
<floor> 1^{st} floor </floor>
<Aisle> 12 </aisle>
<stack> 8 </stack>
<shelf> 2 </shelf>

</location>
...
<Quantity> 1 </Quantity>
<UnitPrice> 12.99 </UnitPrice>
<TotalAmt> 12.99 </TotalAmt>
...

</Item2>
<item_3>

<ItemCode> SU-Shampoo-001 </ItemCode>
<Category> WASH </Category>
<Sub-Category> hair product </Sub-Category>
</ItemName> SUAVE shampoo </ItemName>
<Description> SUAVE shampoo heat treatment 120 mL
</Description>
<location>

...
<floor> 1^{st} floor </floor>
<Aisle> 12 </aisle>
<stack> 9 </stack>
<shelf> 2 </shelf>

</location>
...
<Quantity> 1 </Quantity>
<UnitPrice> 8.99 </UnitPrice>
<TotalAmt> 8.99 </TotalAmt>
...

</item_3>
...

</PurchaseItem>

Within embodiments, upon obtaining purchase item information 203 (e.g., by receiving information from an online shopping cart, by obtaining user self-scanned item information via NFC handshake at a checkout terminal, or by scanning physical items at a PoS terminal, etc.), the merchant 210 may generate a bill 208 upon the obtained purchase item information. For example, the bill may take a similar data structure as the obtained purchase item information 203. In one implementation, the merchant may include an intelligent PoS terminal, which may identify whether a purchase item qualifies for a restricted-use account. For example, when the merchant is equipped with a smart PoS terminal, the terminal may query for a list of eligible types of restricted-use accounts for each purchase item based on the purchase item's item category type code, to determine whether the restricted-use account may be applied to purchase the item. In one implementation, the PoS terminal may generate a restricted-use account white list matching status 206, which may comprise information as to a recommended restricted-use account that may be applied to the item. In further implementations, when the user engages a mobile wallet to scan product items, and/or an online purchase, and MPOC client component may retrieve user specified rules (e.g., see 442b in FIG. 4A, etc.) so that MPOC may determine whether a purchase item qualified for any user specified account (e.g., see 553, 566 in FIG. 5B, etc.). Exemplary PoS terminal may include ACR123 PoS terminal, Verifone PoS, Equinox PoS, and/or the like.

An exemplary XML-formatted message of the restricted-use account status 206 for the merchant 210 may take a form similar to the following:

POST /RestrictStatus.php HTTP/1.1
Host: 216.15.51.74
Content-Type: Application/XML
Content-Length: 718
<?XML version = “1.0” encoding = “UTF-8”?>
<ItemStatus>

<Time> 17:40:40 </Time>
<Date> 09-09-2015 </Date>
...
<user>

<user_id> JS-001 </user_id>
<user_name> John Smith </user_name>
<wallet_id> js_wallet </wallet_id>
<password> ***** </password>
...

</user>
<Item1>

<ItemCode> FOOD-9875 </ItemCode>
<Category> FOOD </Category>
<Sub-Category> Breakfast </Sub-Category>
<RecommendedAct>

<Act1> Food Stamp </Act1>
...

</RecommendAct>

</Item1>
<Item2>

<ItemCode> DRUG-23401 </ItemCode>
<Category> DRUG </Category>
<Sub-Category> Non-Prescription </Sub-Category>
<RecommendedAct>

<Act1> FSA </Act1>
<Act2> HSA </Act2>
...

</RecommendAct>
...

</Item2>
<Item3>

<ItemCode> MS-Shampoo-01 </ItemCode>
<Category> Body Wash</Category>
<Sub-Category> shampoo </Sub-Category>
<RecommendedAct>

<Act1> Regular </Act1>
...

</RecommendAct>
...

</Item3>
...

</ItemStatus>

Within implementations, the merchant 210 may provide an account recommendation message 212 to the user 202, e.g., a message sent to the user's mobile device via NFC handshake, a message displayed on the PoS terminal, and/or the like. For example, in one implementation, as shown in the above example of restricted-use account matching status message 206, when the PoS terminal has determined one or more of the user's purchase items includes healthcare products that are eligible for FSA/HSA expenses, the PoS terminal may generate a MPOC alert asking the user whether the user would like to purchase eligible items using FSA/HSA account, e.g., see 111 in FIG. 1B. An exemplary XML-formatted message of account recommendation message 212 for the user may take a form similar to the following:

POST /AccountAlert.php HTTP/1.1
Host: 216.15.51.74
Content-Type: Application/XML
Content-Length: 718
<?XML version = “1.0” encoding = “UTF-8”?>
<AccountAlert>

<Time> 17:40:40 </Time>
<Date> 09-09-2015 </Date>
...
<Item>
<Item1>

<ItemCode> DRUG-23401 </ItemCode>
<Category> DRUG </Category>
<Sub-Category> Non-Prescription </Sub-Category>
<ItemAlias> NyQuil </ItemAlias>
<RecommendedAct>

<Act1> FSA </Act1>
<Act2> HSA </Act2>
...

</RecommendAct>

...
</Item1>

</Item>
<Message> ″Would you like to pay your NyQuil with your
FSA/HSA?″
</Message>
<HardwareID> JS001 </HardwareID>
<Address> 01:23:45:67:89:ab </Address>
...

</AccountAlert>

In another example, the restricted-use account status 206 may identify eligible items for each restricted-use account if there is any. For example, an exemplary XML-formatted message 206 for the user may take a form similar to the following:

POST /AccountAlert.php HTTP/1.1
Host: 216.15.51.74
Content-Type: Application/XML
Content-Length: 718
<?XML version = “1.0” encoding = “UTF-8”?>
<AccountStatus>

<Time> 17:40:40 </Time>
<Date> 09-09-2015 </Date>
...

<user>

<user_id> JS-001 </user_id>
<user_name> John Smith </user_name>
<wallet_id> js_wallet </wallet_id>
<password> ***** </password>
...

</user>

<ru_account1>

<account_name> FSA </account_name>
<account_category> healthcare </account_category>
<account_type> prepaid </account_type>
<item>

<Item1>

<ItemCode> DRUG-23401 </ItemCode>
<Category> DRUG </Category>
<Sub-Category> Non-Prescription </Sub-Category>
<ItemAlias> NyQuil </ItemAlias>
...

</Item1>
<item_2>

<item_code> DRUG-23402 </item_code>
<category> drug </category>
<sub_category> antibiotics </sub_category>

<item_alias> penicillin </item_alias>

...

</item_2>
...
</Item>

...
</ru_account1>
<ru_account2>

<account_name> food stamp </account_name>
<account_category> government </account_category>
<account_type> food </account_type>
<item>

<Item1>

<ItemCode> food-2307 </ItemCode>
<Category> grocery </Category>
<Sub-Category> produce </Sub-Category>
<ItemAlias> flour </ItemAlias>
...

</Item1>
<item_2>

<item_code> food-3394 </item_code>
<category> grocery </category>
<sub_category> bakery </sub_category>

<item_alias> cupcake </item_alias>

...

</item_2>
...
</Item>

</ru_account2>

...
</Accountstatus>

In one implementation, the user may select an account 214 to proceed with checkout, e.g., by selecting whether to accept payment with a restricted-use account as recommended by the PoS terminal, or to skip the recommendation and proceed with a bank account checkout. In one implementation, the user may submit account information together with the account selection message 214 to the PoS terminal, e.g., by tapping on an electronic wallet, by swiping a magnetic payment card, and/or the like. In one implementation, an exemplary XML formatted user account selection message 214 may take a form similar to the following:

POST /AccountSelection.php HTTP/1.1
Host: 216.15.51.74
Content-Type: Application/XML
Content-Length: 718
<?XML version = “1.0” encoding = “UTF-8”?>
<AccountSelection>

<TimeStamp> 11:11:23 </TimeStamp>
<Date> 09-09-2015 </Date>
<User>
<UserName> John Smith </UserName>
<UserID> JS0000 </UserID>
...
</User>
<Account>
<AccountNo> 0000 0000 0000 </AccountNo>
<AccountType> FSA </AccountType>
<Employer> SuperFast Software Co. </Employer>
<AccountHolder> John Smith </AccountHolder>
<RoutingNumber> 000000000 </RoutingNumber>
...
</Account>
...

</AccountSelection>

Within implementations, upon receiving the user's account selection, the merchant 210 (e.g., the smart PoS terminal, etc.) may generate a payment request message 216 to the MPOC server 220 based on the received purchase item information and the retrieved account usage rules. For example, the payment request message 216 may include transaction data and merchant specific information. The transaction data may include the customer's common account number that is the same for some or all of restricted-use accounts and non-restricted-use accounts. Advantageously, a customer can carry only one card, but, as described below, the card processing network intelligently determines how to route message 216 to the appropriate issuer and determines which of the customer's account will provide a source of funds for a purchase transaction.

In one implementation, the MPOC may generate the payment request message including a processing code in an existing field and a unique identifier to determine how to route a transaction, e.g., whether the transaction involves any restricted-use accounts, etc. The processing code may identify a type of account to be charged for the purchase transaction (e.g., a restricted-use account, a non-restricted use account, etc.). The processing code be a number or other information generated by a merchant's point of sale terminal or on a customer's mobile device based on input provided by a customer when making a purchase transaction. For example, the merchant's point of sale terminal may provide a graphical user interface presenting an onscreen menu permitting a customer to select a desired type of account for a purchase transaction. The account type may be used to indicate whether an account is a restricted use account or a non-restricted use account, and its type (e.g., FSA account, HSA account, HRA account, government assistance account, credit account, debit account, etc.). In an example, the processing code may be a predetermined number of digits (e.g., four digit field) in the message 216. In some examples, the message 216 may include the processing code in an existing field of a transaction processing format. The PoS terminal may generate the processing code to indicate what account the customer selected as a source of funds for the purchase transaction. Message 216 may also include a code for each product and/or service to be purchased (e.g., stock keeping unit (SKU)).

Message 216 may also include merchant specific information. For example, the merchant specification information may include a merchant category code, a merchant identifier, and a unique identifier. The merchant category code may indicate the type of goods and/or services the merchant provides. The merchant identifier may be a number that uniquely identifies the merchant or a particular store location of the merchant. The unique identifier may be a merchant qualification number, as described in further detail below, assigned to the merchant by an issuer processor to indicate that the merchant is eligible to provide goods and/or services under a program associated with a restricted-use account.

In one implementation, the merchant PoS terminal may generate a HTTP POST message to the MPOC server 220, wherein the XML-formatted payment request 216 message may take a form similar to:

<?XML version = “1.0” encoding = “UTF-8”?>
<payment_request>
<PoS_{——}details>

<PoS_IP>192.168.23.126</client_IP>
<PoS_type>merchant</PoS_type>
<PoS_model>MDN001</PoS_model>
...
<app_installed_flag>true</app_installed_flag>

</PoS_details>

<RequestID> SHP-0001 </RequestID>

<RequestDate> 09-09-2015 </BillDate>
<RequestTimeStamp> 14:23:56 </RequestTimeStamp>
<Routing> 01 </Routing>
<one_card_no> 123456789012 </one_card_no>
...
<PurchaseItem>

<Item1>

<ItemCode> DRUG-23401 </ItemCode>
<Category> DRUG </Category>
<Sub-Category> Non-Prescription </Sub-Category>
</ItemName> NyQuil Cold Medicine </ItemName>
<Description> NyQuil Cold&Flu Liquid 80 mL
</Description>
<Quantity> 1 </Quantity>
<UnitPrice> 12.99 </UnitPrice>
<TotalAmt> 12.99 </TotalAmt>
...

</Item1>
...

</PurchaseItem>
<TotalAmount> 12.99 </TotalAmount>

...
</PaymentRequest>

In the above example, in response to a customer swiping his or her MPOC card as part of a purchase transaction, the merchant PoS may read a MPOC card identifier, e.g., the MPOC card number, wallet identifier, etc., and the unique identifier, and generate a processing code based on input provided by a customer. In some examples, the MPOC card identifier may be common to all of the restricted-use and non-restricted-use accounts associated with the MPOC card. To obtain approval for the purchase transaction, the merchant PoS may communicate a payment request message 216 including the processing code, the MPOC card identifier, and the unique identifier to the MPOC server. The MPOC server may process the processing code in the existing field of the message 216 and the unique identifier to determine to which issuer to route the transaction, e.g., field value “1” indicates a FSA account enrolled with the MPOC card and/or wallet, etc. For instance, the processing code may inform the MPOC server which type of account is to be the source of funds for the purchase transaction. If, for example, the account type indicates that a restricted-use account is to be the funds source, the MPOC server may process the unique identifier to confirm that the merchant is an eligible provider. If not, the MPOC server may respond to the merchant's PoS terminal with a decline message. If eligible, the MPOC server may retrieve routing information of a restricted-use account issuer processor for forwarding of the message 216 thereto. The restricted-use account issuer may then determine whether to approve the transaction based on whether the restricted-use account has sufficient funds and whether the products/services are appropriate for purchase using the restricted-use account. In another implementation, the PoS payment request message 216 may include a full PAN number of the account (e.g., FSA for a medical item purchase, etc.) selected and/or determined for the purchase item.

In another implementation, when the user engages a digital wallet (e.g., either online or instore, etc.) for the purchase, the payment request message 216 may include split tender information for categorized items and the respective payment account. An example listing of a payment request 216, substantially in the form of a HTTP(S) POST message including XML-formatted data, is provided below:

POST /authorizationrequests.php HTTP/1.1
Host: www.acquirer.com
Content-Type: Application/XML
Content-Length: 1306
<?XML version = “1.0” encoding = “UTF-8”?>
<payment_request>

<session_ID>4NFU4RG94</order_ID>
<timestamp>2011-02-22 15:22:43</timestamp>
<expiry>00:00:30</expiry>
<alerts_URL>www.merchant.com/shopcarts.php?sessionID=AEBB4356</aler
ts_URL>
<!--optional data-->
<user_ID>john.q.public@gmail.com</user_ID>
<wallet_id> JS001 </wallet_id>
<wallet_PAN> 12344567777 </wallet_PAN>
<gps>

<latitude> 42° 32.96 </latitude>
<longtitude> 74° 11.92 </longtitude>

</gps>
...
<client_{——}details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<purchase_details>

...

<Item1>

<ItemCode> FOOD-9875 </ItemCode>
<Category> FOOD </Category>
<Sub-Category> Breakfast </Sub-Category>
</ItemName> Cereal </ItemName>
<Description> whole grain original 10 oz </Description>
<Quantity> 1 </Quantity>
<UnitPrice> 4.99 </UnitPrice>
<TotalAmt> 4.99 </TotalAmt>
<routing> 1 </routing>
...

</Item1>
<Item2>

<ItemCode> DRUG-23401 </ItemCode>
<Category> DRUG </Category>
<Sub-Category> Non-Prescription </Sub-Category>
</ItemName> NyQuil Cold Medicine </ItemName>
<Description> NyQuil Cold&Flu Liquid 80 mL </Description>
<Quantity> 1 </Quantity>
<UnitPrice> 12.99 </UnitPrice>
<TotalAmt> 12.99 </TotalAmt>
<routing> 1 </routing>
...

</Item2>
<item_3>

<ItemCode> SU-Shampoo-001 </ItemCode>
<Category> WASH </Category>
<Sub-Category> hair product </Sub-Category>
</ItemName> SUAVE shampoo </ItemName>
<Description> SUAVE shampoo heat treatment 120 mL </Description>
<Quantity> 1 </Quantity>
<UnitPrice> 8.99 </UnitPrice>
<TotalAmt> 8.99 </TotalAmt>
<routing> 3 </routing>
...

</item_3>

...

</purchase_details>
<merchant_params>

<merchant_id>3FBCR4INC</merchant_id>
<merchant_name>Acme Supermarket, Inc.</merchant_name>
<merchant_auth_key>1NNF484MCP59CHB27365</merchant_auth_k

ey>
</merchant_params>
...

</payment_request>

In one implementation, the MPOC may create a unique identifier known to the issuer processor and a merchant that allows the issuer processor to identify the account from which to debit funds and to authenticate merchant eligibility to access funds in the account (e.g., a prepaid account) for transactions restricted to approved merchants. For example, in one implementation, such unique identifier may include a merchant id, a merchant checkout terminal id, account id, and/or the like. In some examples, the unique identifier may be a merchant qualification number provided to a merchant by the issuer processor or some other entity. The merchant qualification number may be unique to the merchant or may be unique to a particular store of the merchant. The merchant may obtain the qualification number after registering with and being approved by the issuer to provide a good and/or service for which payment can be made using a restricted-use account. Once approved, the merchant, via its point of sale terminal, may communicate the merchant qualification number as part of the payment authorization request message 216 when requesting approval from the issuer to charge a restricted-use account for a good/service a customer is attempting to purchase.

The MPOC server 220 may obtain a routing number 217 from the received payment request 216, based on which the MPOC may determine where to forward the payment authorization request 218, which may take a similar form to the payment request 216. For example, if the user has elected a credit card account for payment, the MPOC server 220 may route the payment authorization request 218 to the credit card issuing bank. In another example, when the user elected a FSA/HSA account for payment, the MPOC server 220 may route the payment authorization request 218 the FSA/HSA account manager.

In one implementation, the account issuing network 230 may review and verify the payment request. For example, the account issuer may optionally verify whether the account has sufficient remaining balance to furnish the payment, whether the item category code of the purchase item is eligible for usage of the account, and/or the like, e.g., 221. In one implementation, the account issuer network 230 may generate a payment authorization response message 222, e.g., a HTTPS POST message in the form of data formatted according to the XML. Below is an example HTTP(S) POST message including an XML-formatted message of the authorization response 222 for the MPOC server 220:

POST /AuthorizationResponse.php HTTP/1.1
Host: www.issuer.com
Content-Type: Application/XML
Content-Length: 718
<?XML version = “1.0” encoding = “UTF-8”?>
<AuthorizationResponse>

<Time> 17:45:40 </Time>
<Date> 09-09-2015 </Date>
<User>

<UserName> John Smith </UserName>
<UserID> JS0000 </UserID>
<DeviceID> JS-001 </DeviceID>

...
</User>
<Issuer>

<IssuerID> FSA-CA-001 </IssuerID>
<RoutingNo> 00000000 </RoutingNo>
...

</Issuer>
<Account>

<AccountNo> 0000 0000 0000 </AccountNO>
<AccountType> FSA </AccountType>
<Employer> SuperFast Software Co. </Employer>
...

</Account>
<PurchaseItem>

<Item1>

<ItemCode> DRUG-23401 </ItemCode>
<Category> DRUG </Category>
<Sub-Category> Non-Prescription </Sub-Category>
</ItemName> NyQuil Cold Medicine </ItemName>
<Description> NyQuil Cold&Flu Liquid 80 mL
</Description>
<Quantity> 1 </Quantity>
<UnitPrice> 12.99 </UnitPrice>
<TotalAmt> 12.99 </TotalAmt>
...

</Item1>
...

</PurchaseItem>
<TotalAmount> 12.99 </TotalAmount>
<Eligibility> Good </Eligibility>
<Balance> Good </Balance>
<Remaining> 1000.00 </Remaining>
...

</AuthorizationResponse >

In the above example, the account issuer, e.g., a FSA account manager, may verify the item category “drug” is eligible for FSA usage, and the remaining balance “1000.00” is sufficient to cover the requested payment amount of “$14.99.”

Upon receiving the payment authorization 222, the MPOC server 220 may process the payment by transacting a requested amount from the user account to the merchant 210, and send an approval notice 223 to the merchant 210. For example, the MPOC server 220 may send the fund transfer request, which may take a form similar to the format in compliance with electronic fund transfers (EFT), and in some embodiments, it may be directly made to the merchant 210 via a third party bank, e.g., absent the direction of the MPOC server 220. In another implementation, the MPOC server 220 may be integrated with a payment network, e.g., VisaNet, etc., which may facilitate the payment processing. In one implementation, the MPOC server 220 may debit the approved payment amount from the user's account and credit to the merchant 210. In another example, the fund transfer message may take a form similar to the Visa Single Message System (SMS) format, Visa Original Credit Transaction (OCT) format, and/or the like. Further implementations of the purchase transaction authorization are discussed below.

In one implementation, upon obtaining the approval notice 223 of the payment transaction, the merchant 210 may generate a receipt 225 to the user. For example, the user may obtain a printed receipt 213 from a PoS terminal. For another example, the user may obtain an electronic receipt (e.g., via online shopping site, via NFC handshake with the PoS terminal from a mobile device, etc.). In one implementation, receipt 225 may list the user's purchased item information, payment account information, merchant information, and/or the like. In another implementation, the MPOC server 220 may incorporate information in the receipt into a transaction record 226 for storage. For example, an example of the transaction record 266 for the MPOC server may take a form similar to the following:

POST /TransactionRecord.php HTTP/1.1
Host: www.MPOC.com
Content-Type: Application/XML
Content-Length: 718
<?XML version = “1.0” encoding = “UTF-8”?>
<Transaction>

<TransactionID> 000000 </TransactionID>
<TransactionDate> 09-09-2015 </TransactionDate>
<RequestTime> 19:30:27 </RequestTime>
<ReceiptTime> 19:31 :56 </ReceiptTime>
<User>

<UserName> John Smith </UserName>
<UserID> JS0000 </UserID>

...
</User>
...
<Account>

<AccountNo> 0000 0000 0000 </AccountNO>
<AccountType> FSA </AccountType>
<Employer> SuperFast Software Co. </Employer>
<RoutingNo> 000000000 </RoutingNo>
...

</Account>
<PurchaseItem>

<Item1>

<ItemCode> DRUG-23401 </ItemCode>
<Category> DRUG </Category>
<Sub-Category> Non-Prescription </Sub-Category>
<ItemName> NyQuil Cold Medicine </ItemName>
<Description> NyQuil Cold&Flu Liquid 80 mL
</Description>
<Quantity> 1 </Quantity>
<UnitPrice> 12.99 </UnitPrice>
<TotalAmt> 12.99 </TotalAmt>
...

</Item1>
...

</PurchaseItem>
<TotalAmount> 12.99 </TotalAmount>
<Verification> Good </Verification>
<Merchant>

<MerchantID> MC001 </Merchant>
<MerchantName> Walgreens </MerchantName>
<MerchantAddress> ... </MerchantAddress>
<PoSID> MCC-001-001 </PoSID>

...
</Merchant>
<TransferLog>

<Transfer1>

<Amount> 14.99 </Amount>
<Payor> 0000 0000 0000 </Payor>
<Payee> 0000 0000 0002 </Payee>
<Status> Verified </Status>
...

</Transfer1>
...

</TransferLog>

...
</Transaction>

In another implementation, the database 219 may be a relational database responsive to Structured Query Language (“SQL”) commands. The MPOC server may execute a hypertext preprocessor (“PHP”) script including SQL commands to query the database for user, transaction data, and/or the like. An example PHP/SQL command listing, illustrating substantive aspects of storing a transaction record 266 in the database:

<?PHP
header(′Content-Type: text/plain′);
mysql_connect(″202.155.66.130”,$DBserver,$password); // access

database server

mysql_select(″TRANSACTIONS.SQL″); // select database to append
mysql_query(“INSERT INTO Transactions (transaction_id,

transaction_date, requested_time, receipt_time, user_id,
user_name, account_no, account_type, employer, routing_no,
item_code, category, sub_category, item_name, item_description,
item_quantity, unit_price, total_amount, veritifcation_status,
merchant_id, merchant_name, PoS_id, transfer_log, payee_id,
payor_id, transfer_amount ...)

VALUES ($transaction_id$, $transaction_date$, $requested_time$,

$receipt_time$, $user_id$, $user_name$, $account_no$,
$account_type$, $employer$, $routing_no$, $item_code$,
$category$, $sub_category$, $item_name$, $item_description$,
$item_quantity$, $unit_price$, $total_amount$,
$veritifcation_status$, $merchant_id$, $merchant_name$,
$PoS_id$, $transfer_log$, $payee_id$, $payor_id$,
$transfer_amount$...); //

add data to table in database
mysql_close(″TRANSACTIONS.SQL″); // close connection to database
?>

In one implementation, the MPOC may access and retrieve information from one or more online databases 219. Some databases contain a rule for a payment made towards the balance due bill for the healthcare provided by the healthcare worker to the user. By way of example, and not by way of limitation, a database can contain a negative wealth impacting (e.g., deduction, liability, insurance, debt, tax, negative interests, and/or other wealth reducing factor) rule pertaining to payment to the healthcare provider for the healthcare to the user. Another database can contains an insurance rule pertaining to payment for the healthcare to the user. Other online databases accessible by the MPOC to retrieve information can contain data specific to the user and an insured entity financially responsible for the user, as well as currency balances in each of one or more accounts respectively issued by an issuer.

FIG. 2B provides a data flow illustrating alternative implementations of MPOC entity interactions within embodiments of the MPOC. Within implementations, instead of obtaining account recommendation (e.g., 212 in FIG. 2A) at a smart PoS terminal equipped with the merchant 210 and/or the user's mobile wallet, such account recommendation may be provided by the MPOC server 220 upon user submitting purchase item information to the MPOC server 220. In one implementation, in one implementation, upon user submitting purchase item information 203 to the merchant 210, which in term generates a payment bill 208, the user may obtain a bill 211 from the merchant. For example, in one implementation, the merchant may print a paper bill 211 to the user. In another example, the merchant may transmit an electronic bill of the purchase items 211 to the user's electronic wallet. The user's electronic wallet may then determine whether the purchase item information comprises any restricted-use account eligible items. In further implementations, the merchant may generate a QR code for display, as further discussed in FIG. 2C.

Within alternative implementations, the user may check in with the MPOC server 220 with bill information 227. For example, in one implementation, the user's electronic wallet instantiated on a mobile device may automatically send a notification to the MPOC server 220 upon identifying the user's GPS coordinates reflect user's location at a merchant store 210. In another implementation, the user's browser may send a cookie to the MPOC server 220 indicating the user has entered into a merchant shopping site. The user-merchant check-in may take places prior to, after, or in accordance with the user obtaining a purchase bill from the merchant.

Within implementations, the user may also send purchase bill information 227 to the MPOC server 220. For example, in one implementation, the user may forward an electronic bill to the MPOC server 220 via wallet. In another example, the user may operate a camera-enabled mobile device to capture an image of a paper bill, a checkout list displayed at a PoS terminal screen, a QR code generated at a PoS terminal and/or a checkout page at the user's online shopping site, and/or the like, and incorporate the captured image in the message 227 to the MPOC server 220. In another implementation, the user may proceed with 241 in FIG. 2C to obtain bill information embedded in a QR code.

For example, in one implementation, the user's mobile device may generate a HTTPS POST message in the form of data formatted according to XML, wherein the XML-formatted message of the user check-in with bill information message 227 for the MPOC server 220 may take a form similar to the following:

POST /UserCheckin.php HTTP/1.1
Host: 216.15.51.74
Content-Type: Application/XML
Content-Length: 718
<?XML version = “1.0” encoding = “UTF-8”?>
<UserCheckin>

<Time> 17:45:40 </Time>
<Date> 09-09-2015 </Date>
<User>

<UserName> John Smith </UserName>
<UserID> JS0000 </UserID>
<DeviceID> JS-001 </DeviceID>

...
</User>
<GPS> 29.199505,−90.041242 </GPS>
<Bill>

<Item1>

<ItemCode> FOOD-9875 </ItemCode>
<Category> FOOD </Category>
<Sub-Category> Breakfast </Sub-Category>
</ItemName> Cereal </ItemName>
<Description> whole grain original 10 oz </Description>
<Quantity> 1 </Quantity>
<UnitPrice> 4.99 </UnitPrice>
<TotalAmt> 4.99 </TotalAmt>

...
</Item1>
<Item2>

<ItemCode> DRUG-23401 </ItemCode>
<Category> DRUG </Category>
<Sub-Category> Non-Prescription </Sub-Category>
</ItemName> NyQuil Cold Medicine </ItemName>
<Description> NyQuil Cold&Flu Liquid 80 mL
</Description>
<Quantity> 1 </Quantity>
<UnitPrice> 12.99 </UnitPrice>
<TotalAmt> 12.99 </TotalAmt>
...

</Item2>
...

</Bill>
<TotalAmount> 16.99 </TotalAmount>
<Merchant>

<MerchantID> MC001 </Merchant>
<MerchantName> Walgreens </MerchantName>
<MerchantAddress> ... </MerchantAddress>
<PoSID> MCC-001-001 </PoSID>

...
</Merchant>
...

</UserCheckin>

In another implementation, the merchant may submit bill information 212 to the MPOC server 220. As such, the MPOC server may forward bill information to the user via email, SMS, instant messaging, wallet messaging, and/or the like.

In one implementation, upon receiving the user check-in information 227, the MPOC server 220 may query a user database to retrieve user's profile, and determine a list of user payment accounts registered with the electronic wallet. In one implementation, the MPOC server 220 may retrieve routing number 229 with user registered accounts, and submit an update request 231 to the account issuer network 230 for account balance information. The issuer network 230 may in turn retrieve the account information for status check 233a, and generate a status update 233b to the MPOC server. For example, in one implementation, the issuer network 230 may generate a HTTPS POST message in the form of data formatted according to XML, wherein the XML-formatted message of the account update message 233a-b for the MPOC server 220 may take a form similar to the following:

POST /AccountUpdate.php HTTP/1.1
Host: www.issuer.com
Content-Type: Application/XML
Content-Length: 718
<?XML version = “1.0” encoding = “UTF-8”?>
<AccountUpdate>

<Time> 17:45:40 </Time>
<Date> 09-09-2015 </Date>
<User>

<UserName> John Smith </UserName>
<UserID> JS0000 </UserID>
<DeviceID> JS-001 </DeviceID>

...
</User>
<Account>

<AccountNo> 0000 0000 0000 </AccountNO>
<AccountType> FSA </AccountType>
<Employer> SuperFast Software Co. </Employer>
<RoutingNo> 000000000 </RoutingNo>
<Balance> 649.00 </Balance>
<Term>

<start_date> 01/01/2015 </start_date>
<end_date> 12-31-2015 </end_date>

</Term>
...

</Account>
<Status> Good </Status>
...

</AccountUpdate>

In another implementation, the MPOC server 220 may obtain purchase item information from the user provided bill information and perform item eligibility check 228 to see if any item from the bill is eligible for a user enrolled restricted-account usage. For example, in one implementation, the MPOC server 220 may extract purchase item information from the bill submitted with message 227, e.g., a snap bill image, etc., by performing an optical character recognition (OCR) procedure. The MPOC server 220 may then query a user database for user enrolled account, and the information retrieved by the MPOC from the online databases is processed by an optimization algorithm that operates on the rules in the retrieved information. The MPOC may derive a recommendation that includes a currency payment amount to pay against the balance due bill respectively from each said currency balance of the one or more accounts issued by respective issuers. In further implementations, the recommendation may be performed and rendered on the web enabled mobile computing device for approval by the user. If the recommendation is approved, the enabled mobile computing device transmits the recommendation to the PoS. In one implementation, the PoS may transmit the recommendation for authorization processing of each currency payment amount to pay against the balance due bill respectively from each currency balance of each account as provided by the recommendation. In a further implementation, the MPOC may substantially maximize currency payments pay against the balance due bill, as well as substantially minimize out-of-pocket payments pay against the balance due bill. Further implementations of account recommendations are illustrated in FIGS. 5C-5D.

In one implementation, the MPOC server 220 may provide an account listing 235 (add a data structure) to the user, e.g., see 585 in FIG. 5C, and the user may submit an account selection 214 by tapping on an account. Upon obtaining the user selected account, the merchant PoS terminal may process the payment request 216 in a similar manner as discussed in FIG. 2A. For example, in one implementation, an exemplary XML-formatted recommended account listing may take a form similar to:

POST /AccountList.php HTTP/1.1
Host: www.issuer.com
Content-Type: Application/XML
Content-Length: 718
<?XML version = “1.0” encoding = “UTF-8”?>
<AccountList>

<Time> 17:45:56 </Time>
<Date> 09-09-2015 </Date>
<User>

<UserName> John Smith </UserName>
<UserID> JS0000 </UserID>
<DeviceID> JS-001 </DeviceID>

...
</User>
<AccountList>

<Account1>

<AccountType> FSA </AccountType>
<AccountBalance> 100.00 </AccountBalance>
...

<Account1>

<Account2>

<AccountType> HSA </AccountType>
<AccountBalance> 1000.00 </AccountBalance>

...

<Account2>

<Account3>

<AccountType> HRA </AccountType>
<AccountBalance> 200.00 </AccountBalance>

...

<Account3>

</AccountList>
<Status> Good </Status>
...

</AccountList>

FIG. 2C provides a data flow diagram illustrating user-PoS interaction for capturing bill information from a QR code within embodiments of the MPOC. In some implementations, a user, e.g., 202, may desire to purchase a product, service, offering, and/or the like (“product”), from a merchant, e.g., 210, via a merchant online site or in the merchant's store. The user may communicate with a merchant server, e.g., 210, via a client such as, but not limited to: a personal computer, mobile device, television, point-of-sale terminal, kiosk, ATM, and/or the like (e.g., 402). For example, the user may provide user input, e.g., checkout input 241, into the client indicating the user's desire to purchase the product. For example, a user in a merchant store may scan a product barcode of the product via a barcode scanner at a point-of-sale terminal. As another example, the user may select a product from a webpage catalog on the merchant's website, and add the product to a virtual shopping cart on the merchant's website. The user may then indicate the user's desire to checkout the items in the (virtual) shopping cart. The client may generate a checkout request, e.g., 242, and provide the checkout request, e.g., 243, to the merchant server. For example, the client may provide a HTTP(S) GET message including the product details for the merchant server in the form of data formatted according to the XML. Below is an example HTTP(S) GET message including an XML-formatted checkout request for the merchant server: (change it to the drug example)

GET /checkout.php HTTP/1.1
Host: www.merchant.com
Content-Type: Application/XML
Content-Length: 718
<?XML version = “1.0” encoding = “UTF-8”?>
<checkout_request>

<session_ID>4NFU4RG94</session_ID>
<timestamp>2011-02-22 15:22:43</timestamp>
<user_ID>john.q.smith@email.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<purchase_details>
<Item1>

<ItemCode> FOOD-9875 </ItemCode>
<Category> FOOD </Category>
<Sub-Category> Breakfast </Sub-Category>
</ItemName> Cereal </ItemName>
<Description> whole grain original 10 oz </Description>
<Quantity> 1 </Quantity>
<UnitPrice> 4.99 </UnitPrice>
<TotalAmt> 4.99 </TotalAmt>
...

</Item1>
<Item2>

<ItemCode> DRUG-23401 </ItemCode>
<Category> DRUG </Category>
<Sub-Category> Non-Prescription </Sub-Category>
</ItemName> NyQuil Cold Medicine </ItemName>
<Description> NyQuil Cold&Flu Liquid 80 mL </Description>
<Quantity> 1 </Quantity>
<UnitPrice> 12.99 </UnitPrice>
<TotalAmt> 12.99 </TotalAmt>
...

</Item2>
<item_3>

<ItemCode> SU-Shampoo-001 </ItemCode>
<Category> WASH </Category>
<Sub-Category> hair product </Sub-Category>
</ItemName> SUAVE shampoo </ItemName>
<Description> SUAVE shampoo heat treatment 120 mL
</Description>
<Quantity> 1 </Quantity>
<UnitPrice> 8.99 </UnitPrice>
<TotalAmt> 8.99 </TotalAmt>
...

</item_3>
</purchase_details>

</checkout_request>

In some implementations, the merchant server may obtain the checkout request from the client, and extract the checkout detail (e.g., XML data) from the checkout request. For example, the merchant server may utilize a parser such as the example parsers described below in the discussion with reference to FIG. 6. The merchant server may extract the product data, as well as the client data from the checkout request. In some implementations, the merchant server may query, e.g., 244, a merchant database, e.g., 219g, to obtain product data, e.g., 245, such as product pricing, sales tax, offers, discounts, rewards, and/or other information to process the purchase transaction. For example, the database may be a relational database responsive to Structured Query Language (“SQL”) commands. The merchant server may execute a hypertext preprocessor (“PHP”) script including SQL commands to query the database for product data. An example PHP/SQL command listing, illustrating substantive aspects of querying the database, is provided below:

<?PHP
header(′Content-Type: text/plain′);
mysql_connect(“254.93.179.112”,$DBserver,$password); // access

database server

mysql_select_db(“PRODUCTS.SQL”); // select database table to search
//create query
$query = “SELECT product_info product_price tax_linfo_list

offers_list discounts_list rewards_list FROM ProdTable WHERE
product LIKE ′%′
$prod”;

$result = mysql_query($query); // perform the search query
mysql_close(“PRODUCTS.SQL”); // close database access
?>

In some implementations, in response to obtaining the product data, the merchant server may generate, e.g., 246a, a QR pay code, and/or secure display element according to the security settings of the user. The merchant server may provide the QR code to the client, so that the client may display the QR code, and the user may capture the QR code using the user's device to obtain merchant and/or product data for generating a purchase transaction processing request. In alternate implementations, the merchant server may direct the client to communicate the product and/or merchant data required to process the transaction to the user's device via an alternate communication protocol, such as, but not limited to: Wi-Fi™, Bluetooth™ cellular network, SMS, email and/or like communication protocols. For example, the merchant server may direct the client to initiate a plug-in on its system to provide the alternate communication service, and transmit the product and/or merchant data to the user's device via the communication service.

In implementations utilizing a QR code, the merchant server may generate a QR code embodying the product information, as well as merchant information required by a payment network to process the purchase transaction. In some implementations, the QR code may include at least information required by the user device capturing the QR code to generate a purchase transaction processing request, such as a merchant identifier (e.g., a merchant ID number, merchant name, store ID, etc.) and a session identifier for a user shopping session associated with the shopping website/brick-and-mortar store.

In some implementations, the merchant server may generate in real-time, a custom, user-specific merchant-product XML data structure having a time-limited validity period, such as the example ‘QR_data’ XML data structure provided below:

<QR_data>

<order_ID>4NFU4RG94</order_ID>
<timestamp>2011-02-22 15:22:43</timestamp>
<expiry_lapse>00:00:30</expiry_lapse>
<transaction_cost>$34.78</transaction_cost>
<alerts_URL>www.merchant.com/shopcarts.php?sessionID=AEBB4356</aler
ts_URL>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<secure_element>www.merchant.com/securedyn/0394733/123.png</secure_{—}
element>
<purchase_details>
<Item1>

<ItemCode> FOOD-9875 </ItemCode>
<Category> FOOD </Category>
<Sub-Category> Breakfast </Sub-Category>
</ItemName> Cereal </ItemName>
<Description> whole grain original 10 oz </Description>
<Quantity> 1 </Quantity>
<UnitPrice> 4.99 </UnitPrice>
<TotalAmt> 4.99 </TotalAmt>
...

</Item1>
<Item2>

<ItemCode> DRUG-23401 </ItemCode>
<Category> DRUG </Category>
<Sub-Category> Non-Prescription </Sub-Category>
</ItemName> NyQuil Cold Medicine </ItemName>
<Description> NyQuil Cold&Flu Liquid 80 mL </Description>
<Quantity> 1 </Quantity>
<UnitPrice> 12.99 </UnitPrice>
<TotalAmt> 12.99 </TotalAmt>
...

</Item2>
<item_3>

<ItemCode> SU-Shampoo-001 </ItemCode>
<Category> WASH </Category>
<Sub-Category> hair product </Sub-Category>
</ItemName> SUAVE shampoo </ItemName>
<Description> SUAVE shampoo heat treatment 120 mL </Description>
<Quantity> 1 </Quantity>
<UnitPrice> 8.99 </UnitPrice>
<TotalAmt> 8.99 </TotalAmt>
...

</item_3>
</purchase_details>
<merchant_params>

<merchant_id>3FBCR4INC</merchant_id>
<merchant_name>Acme Supermarket, Inc.</merchant_name>
<merchant_auth_key>1NNF484MCP59CHB27365</merchant_auth_k

ey>
</merchant_params>

<QR_data>

In some implementations, the XML data may include a handle, alias, token, or pointer to information stored on a payment network server, rather than encoding all of the actual data required to initiate the transaction, so that the information encoded into the QR code may be advantageously minimized. In some implementations, the merchant may generate a QR code using the XML data. For example, the merchant server may utilize the PHP QR Code open-source (LGPL) library for generating QR Code, 2-dimensional barcode, available at http://phpqrcode.sourceforge.net/. For example, the merchant server may issue PHP commands similar to the example commands provided below:

<?PHP
header(′Content-Type: text/plain′);
// Create QR code image using data stored in $data variable
QRcode::png($data, ‘qrcodeimg.png’);
?>

In alternate implementations, the merchant server may provide, e.g., 246b the XML data to a MPOC server 220, along with a request to generate a QR code. For example, the merchant server may utilize an API call to the MPOC server to request generation of the QR code. The MPOC server may generate the QR code for the merchant server, e.g., 246c, and provide, e.g., 246d, the QR code to the merchant server. For example, the MPOC server may encode the information provided by the merchant into the QR code, and may also advantageously encode security information, time validity information, digital certificate information, anonymous shipping information, QR code generation/processing fee information, etc. into the QR code.

In some implementations, the MPOC server may provide the merchant server with an encryption key (e.g., a Rivest-Shamir-Adleman (“RSA”) private/public key, digital certificate). The merchant may encrypt the custom, user-specific merchant-product XML data structure using the encryption key to generate encrypted purchase data (e.g., using the RSA algorithm). The merchant server may then encode the encrypted data into the QR code. Such a scheme may be employed advantageously, in various embodiments, by the MPOC server to authenticate the merchant for any transaction processing requests related to the user-merchant shopping session.

In some implementations, pre-designed QR codes associated with authenticated with pre-authenticated merchants may be provided to the user device. For example, a user may be browsing an online website on the user's device. The user device may make a HTTP(S) GET request for a webpage from a web server. In some implementations, the web server may, in response to the user device's request for a webpage, generate a query for advertisements to display on the webpage. For example, the web server may search a database, or provide a request to an ad network server (e.g., Akamai) to provide advertisements for embedding into the webpage. In some implementations, the ad network server may utilize keywords, metadata, etc. obtained from the web server (e.g., keywords or metadata associated with the webpage, user profile information, user ID, user browsing history from a cookie stored on the user device, etc.). The ad network may utilize the keywords to generate a query of database(s) for advertisements associated with the keywords, and may obtain advertisements to provide. In some implementations, the ad network server may provide information (e.g., via an API call) on such advertisements (e.g., merchant name, merchant ID, product name, product pricing information, related offers, etc.) to a MPOC server. The MPOC server may generate a QR code based on the information provided by the ad network server, such that a user device may snap the QR code to initiate a purchase transaction for the goods and/or services associated with the QR code (e.g., as provided by the ad network server to the MPOC server). The ad network server may provide the QR as part of the advertisement to the web server, which may in turn embed the advertisement including the QR code into the webpage before providing it to the user device. In alternate implementations, the ad network server/web server may transmit a URL or other identifier of the QR code (ultimately) to the user device, and the user device may make a call (e.g., a HTTP(S) GET request) using the URL of the QR code (e.g., hosted on the MPOC server) to obtain the QR code and display it for the user.

In some implementations, the merchant server may provide the QR code to the client, e.g., 247. For example, the merchant server may provide a HyperText Markup Language (“HTML”) page including a reference to the QR code image and/or secure element image, such as the example HTML page below:

<html>

<img src=“www.merchant.com/securedyn/0394733/qrcodeimg.png”
alt=”Merchant-Product QR code”/>
<img src=“ www.merchant.com/securedyn/0394733/123.png”
alt=”Secure Element”/>

</html>

In some implementations, the client may obtain the QR pay code, e.g., 247, and display the QR code, e.g., 248 on a display screen associated with the client device. In some implementations, the user may utilize a user device, e.g., 205, to capture the QR code presented by the client device for payment processing. For example, the user may provide payment input into the user device, e.g., 249. In various implementations, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. For example, the user device may obtain track 1 data from the user's card (e.g., credit card, debit card, prepaid card, charge card, etc.), such as the example track 1 data provided below:
% B123456789012345̂PUBLIC/J.Q.̂99011200000000000000**901******?* (wherein ‘123456789012345’ is the card number of ‘J.Q. Public’ and has a CVV number of 901. ‘990112’ is a service code, and *** represents decimal digits which change randomly each time the card is used.)

In some implementation, the user device may determine whether an image it has captured depicts a QR code. Depending on whether or not a QR code has been captured, and also (optionally) depending on contents of the QR code, the user device may redirect the user (e.g., via a web browser application executing on the user device) to: a product, a merchant website, a product at a merchant website, a website and including a command to add an item to a purchasing cart of the user associated with the website, and/or the like. For example, the user device may execute a component such as the example Quick Response Code Processing (“QRCP”) component described below in the discussion with reference to FIGS. 6A-B.

In some implementations, upon obtaining the user payment input and capturing the QR code, the user device may generate a restricted-account option alert 250 (e.g., to notify the user an option to proceed with a restricted-account payment, etc.). In an alternative implementation, upon capturing purchase item information from the QR code, the user may proceed with 227 in FIG. 2B, e.g., to check-in and submit purchase item information to the MPOC server 220, which may in turn returns a restricted-account option alert 261 for display on the user device 205.

In another implementation, upon obtaining the QR code, the user device may provide a card authorization request, on behalf of the user, a HTTP(S) GET message including the product order details for the MPOC server 220, in the form of XML-formatted data. Below is an example HTTP(S) GET message including an XML-formatted card authorization request for the MPOC server:

GET /purchase.php HTTP/1.1
Host: www.merchant.com
Content-Type: Application/XML
Content-Length: 1306
<?XML version = “1.0” encoding = “UTF-8”?>
<purchase_order>

<order_ID>4NFU4RG94</order_ID>
<alerts_URL>www.merchant.com/shopcarts.php?sessionID=AEBB4356</aler
ts_URL>
<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<purchase_details>
<Item1>

<ItemCode> FOOD-9875 </ItemCode>
<Category> FOOD </Category>
<Sub-Category> Breakfast </Sub-Category>
</ItemName> Cereal </ItemName>
<Description> whole grain original 10 oz </Description>
<Quantity> 1 </Quantity>
<UnitPrice> 4.99 </UnitPrice>
<TotalAmt> 4.99 </TotalAmt>
...

</Item1>
<Item2>

<ItemCode> DRUG-23401 </ItemCode>
<Category> DRUG </Category>
<Sub-Category> Non-Prescription </Sub-Category>
</ItemName> NyQuil Cold Medicine </ItemName>
<Description> NyQuil Cold&Flu Liquid 80 mL </Description>
<Quantity> 1 </Quantity>
<UnitPrice> 12.99 </UnitPrice>
<TotalAmt> 12.99 </TotalAmt>
...

</Item2>
<item_3>

<ItemCode> SU-Shampoo-001 </ItemCode>
<Category> WASH </Category>
<Sub-Category> hair product </Sub-Category>
</ItemName> SUAVE shampoo </ItemName>
<Description> SUAVE shampoo heat treatment 120 mL </Description>
<Quantity> 1 </Quantity>
<UnitPrice> 8.99 </UnitPrice>
<TotalAmt> 8.99 </TotalAmt>
...

</item_3>
</purchase_details>
<merchant_params>

<merchant_id>3FBCR4INC</merchant_id>
<merchant_name>Acme Supermarket, Inc.</merchant_name>
<merchant_auth_key>1NNF484MCP59CHB27365</merchant_auth_k

ey>
</merchant_params>
<account_params>

<account_name>John Smith</account_name>
<account_type>credit</account_type>
<account_num>123456789012345</account_num>
<billing_address>123 Green St., Norman, OK 98765</billing_address>
<phone>123-456-7809</phone>
<sign>/jqp/</sign>
<confirm_type>email</confirm_type>
<contact_info>john.q.public@gmail.com</contact_info>

</account_params>
<shipping_info>

<shipping_adress>same as billing</shipping_address>
<ship_type>expedited</ship_type>
<ship_carrier>FedEx</ship_carrier>
<ship_account>123-45-678</ship_account>
<tracking_flag>true</tracking_flag>
<sign_flag>false</sign_flag>

</shipping_info>

</purchase_order>

In some implementations, the card authorization request generated by the user device may include a minimum of information required to process the purchase transaction. For example, this may improve the efficiency of communicating the purchase transaction request, and may also advantageously improve the privacy protections provided to the user and/or merchant. For example, in some implementations, the card authorization request may include at least a merchant ID, a session ID for the user's shopping session with the merchant, and a device ID of a device (e.g., smartphone) of the user that is linked to the user's virtual wallet. In some implementations, the QR code and messages sent to/from the QR-code capturing device may include the source ID (e.g., identifier of the device generating the QR code), session ID, merchant ID, item ID (e.g., model number), the charge amount, and/or transacting device ID (e.g., the user's smartphone device).

In some implementations, the card authorization request may be provided by the merchant server or point of sale terminal, instead of the user device. In some implementations, the user, desiring security, may request, via the user device, the MPOC server for a dynamically-generated card verification value code (dCVV™) to be utilized along with the user's primary account number (“PAN,” e.g., credit card number) in the purchase transaction. In response, the payment network server may generate a dCVV™ code (e.g., using random number generation, MD5 hash of an input key, which may be generated using the user ID, merchant ID, session ID, timestamp, combinations thereof, and/or the like), and provide a session-specific dCVV™ code for the user to utilize along with the user's PAN number. For example, the session-specific dCVV™ code may have an expiry time (e.g., expiry in a one minute from issue). The user device may communicate (e.g., via Bluetooth™, NFC, Wi-Fi, cellular, QR code, etc.) the PAN and dCVV to the point-of-sale terminal, which may create the card authorization request. For example, the user device may generate a QR payment code embedding the PAN and dCVV numbers, and the point of sale terminal may snap an image of the user device-generated QR payment code. The point of sale terminal may then generate and provide the card authorization request to the MPOC server. In example, the point of sale terminal may generate the card authorization request having encrypted or clear-text versions the PAN and dCVV numbers, or may generate the card authorization request in other manners as described herein. The MPOC server may then be able to validate the transaction by comparing the dCVV obtained from the merchant with the dCVV it provided to the user device before the purchase transaction was initiated. If the dCVV codes from the two sources (MPOC server and merchant) correspond properly to each other, the MPOC server may continue processing the purchase transaction.

In some implementations, the card authorization request from a user device may include encrypted data extracted from the QR code, which may have been encrypted by the merchant server as part of a merchant authentication scheme. In some implementations, the MPOC server may obtain the encrypted data from the card authorization request provided by the user device, and attempt to decrypt the encrypted data, e.g., using a RSA private/public that is complementary to the key the MPOC server initially provided to the merchant server for encrypting the purchase data before embedding it into the QR code. If the MPOC server is able to decrypt the purchase data, then the merchant is authenticated as being a valid merchant. In some implementations, the MPOC server may compare the purchase data decrypted from the card authorization with data provided by the user/user device, to determine whether the data from these different sources (user/user device, and merchant) correspond properly to each other. Thus, in some implementations, the MPOC server may be able to authenticate the merchant, and correlate the merchant to a specific user session or user device before processing the transaction.

In some implementations, the MPOC server may provide a notification to the user device that the transaction is authenticated and approved for transacting. In alternate implementations, the MPOC server may proceed with transaction processing. In some implementations, upon identifying that the user is in a session with the merchant, the MPOC server may communicate with the user device to provide additional features for the user. For example, in some implementations, the MPOC server may provide a communication to the user device (e.g., via a HTTP(S) POST message) to provide: a virtual storefront of the merchant; a depiction of an aisle of the merchant associated with the products included in the card authorization request, a listing of related items; and/or the like.

FIGS. 3A-3D provide logic flow diagrams illustrating various embodiments of restricted-use account payment and reimbursement process flows within embodiments of the MPOC. As shown in FIG. 3A, in one implementation, a user 302 may submit purchase items to a merchant 305 at a PoS checkout terminal, a checkout page at an online shopping site, etc. The merchant 310 may scan purchase item information 306 and determine whether an item is eligible for a restricted-use account usage 308. For example, the merchant PoS terminal may be installed with a software kit to query a list of eligible item category codes associated with a restricted-use account.

In another implementation, the user may submit wallet information to the merchant terminal 310, e.g., by check-in at the merchant at 321, so that the merchant may have wallet information of the user as to which restricted-use accounts the user has enrolled with. The user wallet check-in may further comprise MPOC server updating account balance information 323 to determine whether an account has sufficient funds to fulfill a payment.

In one implementation, if an item is eligible for a restricted-use account 309, the merchant may generate an account recommendation 311, e.g., by sending a MPOC alert to the user device via NFC, or display the message on a user PoS terminal user interface, 312. The user may elect to submit a checkout preference 313, e.g., by selecting to proceed checkout with the eligible restricted-use account or not. If the user has selected to check out with the recommended restricted-use account 314, the merchant may generate a separate bill for the eligible items 315 exclusively for payment using the corresponding restricted-use account.

In another implementation, if no item is eligible for any restricted-use account 309, or the user selects not to check out with the restricted-use account, the merchant may generate a bill of all purchase items 317.

In one implementation, the user may submit an account selection 315 in response to the generated bill at 315 or 317 to proceed with purchase payment transaction (e.g., see also 1416 in FIGS. 14A-14B). Upon receiving the account selection 324, continuing on with 3B, the MPOC server may determine an issuer routing number 326 from the account selection, and generate a payment authorization message and route to the account issuer 328.

In one implementation, the issuer network 330 may receive and process the payment transaction request 331. If the account issuer issues a restricted-account 332, the issuer may further inspect the item eligibility 334, e.g., by verifying the item category code in the payment transaction request satisfies the restricted-use account requirement. The issuer may further generate a response message 335 upon verifying item eligibility, account balance, etc., to the MPOC server 320.

In one implementation, if the issuer response approves the transaction 336, the MPOC server 320 may transact the approved payment amount 337, e.g., by transferring the approved amount from the user account to a merchant account, and generate a transaction receipt message 339 to the merchant. In another implementation, if the transaction is denied by the issuer (e.g., insufficient balance in the selected account, item category code ineligible for a restricted-use account, etc.), the merchant may be notified of the rejection in a transaction denial message 341.

In one implementation, upon completing the transaction, the merchant may receive a transaction receipt message 343, based on which the merchant PoS terminal, or the shopping site, may generate a receipt reflecting the purchase 346 to the user. For example, the user may obtain a printed receipt from a PoS terminal. In another example, the user may obtain an electronic receipt via email, SMS, electronic wallet notifications, and/or the like.

With reference to FIG. 3C, the user may check-in at a merchant store via the electronic wallet. In one implementation, the user 302 may submit wallet check-in information 351, e.g., GPS coordinates, user credentials, and/or the like. Upon receiving the wallet check-in information 352, the MPOC server 320 may determine merchant characteristics 353, e.g., based on GPS coordinates, etc., and tentatively retrieve a list of restricted-use use account in the wallet 354. For example, the MPOC server 320 may retrieve accounts the user has enrolled in the electronic wallet. In another example, the MPOC server may retrieve user enrolled restricted-use accounts based on merchant characteristics, e.g., FSA/HSA and other healthcare related restricted-use accounts if the merchant is a hospital, physician office, dental office, and/or the like; food stamp, etc., if the merchant is a grocery store, and/or the like.

In one implementation, the MPOC server 320 may extract routing information and send a status update request to account issuer 356. The account issuer may then retrieve user account information 357, e.g., balance information, valid term, etc., and generate account status update information 358 for the user.

In one implementation, upon shopping with a merchant, the user 302 may submit purchase information to the merchant 305, which may generate a purchase bill and/or a QR code 360 (e.g., see FIG. 3E). The user may snap an image of the bill (and/or the QR code) and submit the bill image to the MPOC server 361, e.g., via the electronic wallet.

In one implementation, upon receiving bill image information, the MPOC server 320 may perform an OCR procedure to obtain item information 363. For example, the MPOC server 320 may adopt OCR software such as, but not limited to OmniPage, OCRFeeder, Scantron, Java OCR, and/or the like to extract information from a bill image. In an alternative implementation, the user device may perform bill analysis to obtain information as to the purchase item. For example, the user device may decode the QR code and generate an account option based on the purchase item category code 362.

With reference to FIG. 3D, upon OCR scanning of the received bill image, for each item on the bill 364, the MPOC server 320 may determine whether such item is eligible for a restricted-use account. In one implementation, the MPOC server may perform the match 365 based on enrolled restricted-accounts in the user's wallet; such account information may be retrieved at 354. For example, if the user has FSA, HSA accounts enrolled in the wallet, the MPOC server may query each item's item category code to determine whether it is an eligible healthcare product.

In one implementation, if an item is eligible for a restricted-use account 365, upon obtaining the status update of the restricted-use account 366, the MPOC server may generate a restricted-use account option list 367, e.g., including a recommendation of accounts (as further discussed in FIGS. 5D-5F). Upon receiving account recommendation 368, the user may submit a checkout account, e.g., whether to proceed with a restricted-account checkout or not, and proceed with 324 in FIG. 3A.

With reference to FIG. 3E, in some implementations, a user may desire to purchase a product, service, offering, and/or the like (“product”), from a merchant via a merchant online site or in the merchant's store. The user may communicate with a merchant server via a client. For example, the user may provide user input, e.g., 371, into the client indicating the user's desire to checkout shopping items in a (virtual) shopping cart. The client may generate a checkout request, e.g., 372, and provide the checkout request to the merchant server. The merchant server may obtain the checkout request from the client, and extract the checkout detail (e.g., XML data) from the checkout request, e.g., 373. For example, the merchant server may utilize a parser such as the example parsers described below in the discussion with reference to FIG. 6. The merchant server may extract the product data, as well as the client data from the checkout request. In some implementations, the merchant server may query, e.g., 374, a merchant database to obtain product data, e.g., 375, such as product pricing, sales tax, offers, discounts, rewards, and/or other information to process the purchase transaction.

In response to obtaining the product data, the merchant server may generate, e.g., 376, a QR pay code, and/or secure display element according to the security settings of the user (see, e.g., 358). For example, the merchant server may generate a QR code embodying the product information, as well as merchant information required by a payment network to process the purchase transaction. For example, the merchant server may first generate in real-time, a custom, user-specific merchant-product XML data structure having a time-limited validity period.

In some implementations, the merchant may generate QR code using the XML data. For example, the merchant server may utilize the PHP QR Code open-source (LGPL) library for generating QR Code, 2-dimensional barcode, available at http://phpqrcode.sourceforge.net/. For example, the merchant server may issue PHP commands similar to the example commands provided below:

<?PHP
header(′Content-Type: text/plain′);
// Create QR code image using data stored in $data variable
QRcode::png($data, ‘qrcodeimg.png’);
?>

The merchant server may provide the QR pay code to the client, e.g., 376. The client may obtain the QR pay code, and display the QR code, e.g., 377 on a display screen associated with the client device. In some implementations, the user may utilize a user device, e.g., 379, to capture the QR code presented by the client device for payment processing. The client device may decode the QR code to extract the information embedded in the QR code. For example, the client device may utilize an application such as the ZXing multi-format 1D/2D barcode image processing library, available at http://code.google.com/p/zxing/ to extract the information from the QR code. In some implementations, the user may provide payment input into the user device, e.g., 378. Upon obtaining the user purchase input, the user device may generate a card authorization request, e.g., 379, and provide the card authorization request to a MPOC server.

In another implementation, upon obtaining information from the QR code, the user device may submit an account selection to the MPOC server (e.g., see 324 in FIG. 3A) to proceed with a purchase transaction. In further implementation, the user device may submit the QR code to the MPOC server for processing.

FIG. 4A provides a data block diagram illustrating data flow between payment entities (MPOC server, user and affiliated entities) for MPOC account issuer account registration and account usage rules configurations within embodiments of the MPOC. Within various embodiments, as shown in FIG. 4A, one or more consumer(s) 402, MPOC server 420, MPOC database(s) 419, merchant(s) 410, an account issuer 470, and/or the like are shown to interact via various communication networks 413 to facilitate MPOC account management.

Within embodiments, the MPOC server 420, or an account issuer 470 may act as a BIN sponsor. For example, the user 402 may submit a registration request 442a to the MPOC server 420 in order to add a restricted-use account (e.g., FSA/HSA, LOC, Medicare, Medicaid, employee benefit program, food stamp, etc.) to the electronic wallet. For example, in one implementation, the user may fill in an online application form, may call up a wallet management agent, may send a request via instant messages, emails, and/or the like. In another implementation, the user may be provided the option to register with MPOC service when the user enrolls in a healthcare benefit program. For example, an XML-formatted user registration request including user information 442a may take a form similar to the following:

POST /RegistrationRequest.php HTTP/1.1
Host: 64.255.64.00
Content-Type: Application/XML
Content-Length: 718
<?XML version = “1.0” encoding = “UTF-8”?>
RegistrationRequest>
<Time> 17:42:40 </Time>
<Date> 09-01-2014 </Date>
<RequestType> Add Account </RequestType>
<RequestID> JS09012011 </RequestID>
<User>

<UserName> John Smith </UserName>
<WalletID> JS0000 </UserID>
<Password> 0000 </Password>
<PasswordQ>

<Question1> Where were you born </Question1>
<Answer1> New York </Answer1>
...

</PasswordQ>
<Phone>

<Cell> 000-000-0000 </Cell>
<Day> 111-111-1111 </Day>

...
</Phone>
<Address>

<Line1> 122 Apple Ave </Line1>
<City> Big City </City>
<State> CA </State>
<ZipCode> 49920 </Zipcode>

</Address>
...

</User>
<Account>

<AccountType> FSA </AccountType>
<AccountNo> 123456 </AccountNo>
<BIN> FSA-00133 </BIN>
...

</Account>

...

</RegistrationRequest>

In another implementation, the consumer may optionally specify account usage rules 442b. For example, in one implementation, the consumer may specify usage of the account based on product category (e.g., item category code, etc.), e.g., travel related expenses such as hotel, flight tickets, etc., should be charged from the account. In another example, the consumer may specify usage based on payment amount, e.g., any one-time payment greater than $1000.00 should be charged from the enrolled account, etc. In another example, the consumer may specify on usage frequency of the account, e.g., no more than 5 times a week, etc. In one implementation, an XML-formatted consumer registration request including consumer account restricted usage rules 442b may take a form similar to the following:

POST /RestrictUsage.php HTTP/1.1
Host: 64.255.64.00
Content-Type: Application/XML
Content-Length: 718
<?XML version = “1.0” encoding = “UTF-8”?>
RegistrationRequest>
<Time> 17:42:40 </Time>
<Date> 09-01-2014 </Date>
<RequestType> Add Account </RequestType>
<RequestID> JS09012011 </RequestID>
<User>

<UserName> John Smith </UserName>
<WalletID> JS0000 </UserID>
...

</User>
<Rule>

<UsageCategory>

<category_code> AIR-000 <category code>
<Priority_1>

<Account>

<AccountType> Credit </AccountType>
<AccountNo> 0000 0000 0000 0000 </AccountNo>
<Expiry> 2025-10 </Expiry>
<RoutingNo> 000000000 </RoutingNo>
<CCV> 000 </CCV>

...
</Account>

</Priority_1>
<Priority_2>

<Account>

<AccountType> Credit </AccountType>
<AccountNo> 0000 0000 0000 0001 </AccountNo>
<Expiry> 2025-10 </Expiry>
<RoutingNo> 000000001 </RoutingNo>
<CCV> 001 </CCV>

...
</Account>

</Priority_2>

...
</UsageCategory>
...

</Rule>

...

</RegistrationRequest>

In the above example, the consumer has specified account usage rules while enrolling a credit card account into his/her MPOC wallet, e.g., any purchase of the merchant category code “AIR-000” would be charged to this card with highest priority. In another implementation, the rule may be made based on transaction amount, e.g., any purchase over $1000.00 would be charged to this card with highest priority, and/or the like. For example, an example listing of the restriction rule may take a form similar to the following:

POST /RestrictUsage.php HTTP/1.1
Host: 64.255.64.00
Content-Type: Application/XML
Content-Length: 718
<?XML version = “1.0” encoding = “UTF-8”?>
RegistrationRequest>
<Time> 17:42:40 </Time>
<Date> 09-01-2014 </Date>
<RequestType> Add Account </RequestType>
<RequestID> JS09012011 </RequestID>
<User>

<UserName> John Smith </UserName>
<WalletID> JS0000 </UserID>
...

</User>
<Rule>

...
<Amount>

<Min> 1000.00 </Min>
<Priority_1>

<Account>

<AccountType> Credit </AccountType>
<AccountNo> 0000 0000 0000 0000 </AccountNo>
<Expiry> 2025-10 </Expiry>
<RoutingNo> 000000000 </RoutingNo>
<CCV> 000 </CCV>

...
</Account>

</Priority_1>
<Priority_2>

<Account>

<AccountType> Credit </AccountType>
<AccountNo> 0000 0000 0000 0001 </AccountNo>
<Expiry> 2025-10 </Expiry>
<RoutingNo> 000000001 </RoutingNo>
<CCV> 001 </CCV>

...
</Account>

</Priority_2>
...

</Amount>

...

</Rule>

...

</RegistrationRequest>

In one implementation, the MPOC may provide virtual prepaid card including a card number without sending physical magnetic cards, e.g., an electronic mobile wallet entry 451 for the user to download and instantiate on his mobile wallet (e.g., see electronic wallet UIs in FIGS. 5C-5D). For example, in further implementations, an additional wallet may be created for general spends.

In further implementations, funds on the additional healthcare wallet account may be separately loaded by the user. For example, fund loading to a FSA/HSA account may be performed by the user setting aside a portion of his income. In another implementation, the user may select a “back-up” account (e.g., a credit card account, a debit account, etc.) as a default account for user co-pay if payment request via the selected healthcare benefit account is denied by the account issuer 470, e.g., an ineligible healthcare service, etc.

In one implementation, the MPOC server 420 may retrieve the user's wallet information 443, and determine a routing destination 444 of the added account from the healthcare benefit program information 442, to generate a verification request 446 to the account issuer entity 470. For example, the verification request 446 may comprise information fields similar to that of the user submitted restricted-use account information 442. Below is an example HTTP(S) POST message including an XML-formatted message of the account access/verification request message 446:

POST /AccessRequest.php HTTP/1.1
Host: www. MPOC.com
Content-Type: Application/XML
Content-Length: 718
<?XML version = “1.0” encoding = “UTF-8”?>
<AccessRequest>

<Time> 17:42:52 </Time>
<Date> 09-09-2014 </Date>
<RegistrationID> JS09012011 </RegistrationID>
<Account>
<AccountType> FSA </AccountType>
<AccountNo> 123456 </AccountNo>
<BIN> FSA-00133 </BIN>
...
</Account>
...
<User>

<UserName> John Smith </UserName>
<UserID> JS0000 </UserID>
<AccountNo> 0000 0000 0000 </AccountNo>
<Password> 0000 </Password>
<Question1> Where were you born </Question1>
<Answer1> New York </Answer1>
</Password>
...

</user>
...

</AccessRequest>

Within implementations, the account issuer entity 470 may verify the credentials and authorize the access request from MPOC. For example, the account issuer 470 may determine whether user credentials, confirmation, etc. are received to indicate authorization from account owner, whether the benefit sponsor allows the access, etc. In one implementation, the account issuer 470 may provisionally make a small amount deposit into the account that MPOC attempts to link to, e.g., $0.65, etc., and request the user to enter the numeric value of the deposit to prove authorization. For example, the user may receive confirmation request via email, instant messaging, phone calls, text messages, wallet notices, and/or the like, to provide the deposited numeric value. For another example, the account issuer 470 may contact a healthcare benefit program sponsor (e.g., a government agency representative, an employer, etc.) to verify the account access request 446.

In one implementation, the healthcare sponsor entity 470 may verify the status 447 of the restricted-use account, and may send a status including the currently available balance 448 to the MPOC server. For example, the account issuer entity 470 may generate a HTTPS POST message including an XML-formatted status message 448 may take a form similar to the following:

POST /FSAstatus.php HTTP/1.1
Host: 64.255.64.00
Content-Type: Application/XML
Content-Length: 718
<?XML version = “1.0” encoding = “UTF-8”?>
<FSAstatus>
<Time> 17:45:40 </Time>
<Date> 09-01-2014 </Date>
<User>

<UserName> John Smith </UserName>
<WalletID> JS0000 </UserID>
<Password> 0000 </Password>
...

</User>
<Account>

<AccountType> FSA </AccountType>
<AccountNo> 123456 </AccountNo>
<BIN> FSA-00133 </BIN>
<Token> %%\hat{ }&SDSADFWF </Token>
<Balance> 3000.00 </Balance>
<LastUpdate> 17:45:00 </LastUpdate>
...

```
  </Account>
  <Rule>
```

<Maximum> 3000.00 </Maximum>
<ClearancePeriod> 24 hrs </ClearancePeriod>
<Term>

<StartDate> 01-01-2015 </StartDate>
<EndDate> 12-31-2015 </EndDate>
...

</Term>
<ProcedureList>

<Code1> 000 </Code1>
<Code2> ... </Code2>

</ProcedureList>

...
</Rule>
...
</FSAstatus>

Within implementations, the MPOC server 420 may constantly, periodically, and/or intermittently send inquiries to the healthcare benefit sponsor entity 470 for available balance updates.

In one implementation, upon verifying with the account issuer entity 470, the MPOC server 420 may generate an additional entry 449 on the user's electronic wallet 443, wherein the entry may comprise the added account information, user verification information, restricted-use account rules, and/or the like that may prompt the user to provide additional payment method into the electronic wallet. In one implementation, the MPOC mobile wallet entry 449 including the payment account entry, may take a form similar to the following XML-formatted data message:

< MPOCentry>

<UserName> John Smith </UserName>
<UserID> JS0000 </UserID>
<UserContactNo> 000 000 0000 </UserContactNo>
<Password> 0000 </Password>
<PasswordQ>

<Question1> Where were you born </Question1>
<Answer1> New York </Answer>
...

</PasswordQ>
<Account>

<AccountType> FSA </AccountType>
<AccountNo> 123456 </AccountNo>
<BIN> FSA-00133 </BIN>
<Token> %%\hat{ }&SDSADFWF </Token>
<Balance> 3000.00 </Balance>
<LastUpdate> 17:45:00 </LastUpdate>

...
</Account>
<Rule>

<Maximum> 3000.00 </Maximum>
<ClearancePeriod> 24 hrs </ClearancePeriod>
<Term>
<StartDate> 01-01-2015 </StartDate>
<EndDate> 12-31-2015 </EndDate>
...
</Term>
<ProcedureList>
<Code1> 000 </Code1>
<Code2> ... </Code2>
</ProcedureList>

...
</Rule>
<Certificate>

<UserToken> fdsjreiorrgr8t9340548 </UserToken>
</DigitalCertificate> rfsfsuifuisduifu </DigitalCertificate>
<Hash> 00000 </Hash>
...

</Certificate>

...
</ MPOCentry>

In further implementation, the new wallet account entry 451 may be provided to the user wallet, e.g., the user may view a newly added “FSA” account into his wallet, and the account record 452 may be saved at the database 419. For example, the MPOC server may execute a hypertext preprocessor (“PHP”) script including SQL commands to query the database for wallet account data, and/or the like. An example PHP/SQL command listing, illustrating substantive aspects of storing a wallet account entry 452 in the database:

<?PHP
header(′Content-Type: text/plain′);
mysql_connect(″202.155.66.130”,$DBserver,$password); // access

database server

mysql_select(″WALLET_ENTRY.SQL″); // select database to append
mysql_query(“INSERT INTO Wallet_Entry (user_id, user_name,

user_password, user_contact, user_passwordQ, account_type,
account_no, account_BIN, account_token, account_balance,
Account_lastupdate, rule_maximum, clear_period, start_date,
end_date,..., certificate ...)

VALUES ($user_id$, $user_name$, $user_password$, $user_contact$,

$user_passwordQ$, $account_type$, $account_no$,
$account_BIN$, $account_token$, $account_balance$,
$Account_lastupdate$, $rule_maximum$, $clear_period$,
$start_date$, $end_date$,..., $certificate$ ...) //

add data to table in database
mysql_close(″Wallet_Entry.SQL″); // close connection to database
?>

In one implementation, the associated applicability rules 454 may be provided to a list of healthcare providers 410 for pre-check purposes. For example, the MPOC server 420 may provide the applicability rule to healthcare providers within a range of zip codes based on the user's location, and/or the like. For example, the MPOC server may generate a HTTPS POST message including an XML-formatted applicability rules message 454, which may take a form similar to the following:

POST /Rules.php HTTP/1.1
Host: 64.255.64.00
Content-Type: Application/XML
Content-Length: 718
<?XML version = “1.0” encoding = “UTF-8”?>
<Rules>
<Time> 17:45:55 </Time>
<Date> 09-05-2014 </Date>
<AccountType> FSA </AccountType>
<AccountSponsor> FSA-PPA </AccountSponsor>
<ApplicableMerchant>

<MerchantCode1> MC0001 </MerchantCode1>
<MerchantCode2> ... </MerchantCode2>
...

</ApplicableMerchant>
<ApplicableProducts>

<ProductCode1> PA001 </ProductCode1>
<ProductCode2> ... </ProductCode2>
...

</ApplicableProducts>
<Procedures>

<ProcedureCode1> KH0938 </ProcedureCode1>
...

</Procedures>
...
</Rule>

In the above example, the MPOC may provide a list of applicable healthcare providers, products, procedures and/or the like, which are applicable for FSA account usage, to a healthcare provider. In further implementations, a user may configure user submitted rules for account usage, as further discussed below.

FIG. 4B provides a logic flow diagram illustrating MPOC restricted use account enrollment within embodiments of the MPOC. Within embodiments, a user 402 may submit enrollment request 405 (e.g., including restricted use account FSA/HSA/LOC account number, Medicare/Medicaid insurance ID, and/or the like), and wallet information. In another implementation, the consumer may submit account usage rules 406 accompanying the account enrollment information, e.g., see 442b in FIG. 4A.

In another implementation, the MPOC 420 may retrieve user wallet information 408, and determine a type of the account (e.g., FSA/HSA, food stamp, Medicare/Medicaid, unemployment benefit, etc.) 411. The MPOC may retrieve restricted use regulation rules 414, and determine whether it is qualified for enrollment with the wallet 416, e.g., whether the regulatory policy permits the enrollment. If not, the user may receive a denial notice 428. If yes, the MPOC may route the enrollment request to the account issuer 422 for verification 422.

In one implementation, the account issuer 470 may verify the account credentials 425, user profile, account status 427, and/or the like. If the account is in good standing 429, the account issuer may generate and send a token for account access 431 to the MPOC, and the most recent balance information and account rules 433 to the MPOC. For example, in one implementation, the account rules may include a list of procedure/product code and/or merchant category code (MCC), and/or an item category code applicable for the account usage.

In one implementation, the MPOC may store the security token and add a wallet entry 430 to the wallet “my account” list, and the enrolled account is ready to use with wallet payment.

FIG. 5A-5D provide logic flows and exemplary mobile UIs illustrating account recommendation based on account usage rules within embodiments of the MPOC. With reference to FIG. 5A, within embodiments, the consumer 502 may submit purchase item information 505a, e.g., by bringing purchase items to a merchant PoS counter so that the items may be scanned 506 at the checkout counter. In another implementation, the consumer may submit MPOC payment information 505b by instantiating a MPOC mobile application, e.g., via NFC handshake with a smart PoS 520, and retrieve a set of MPOC rules 506b. In one implementation, the MPOC rules retrieved at 506b may include user specified usage rules (e.g., see 133 in FIG. 1D), and/or restricted-use account usage rules specified by the program administer (e.g., FSA/HSA usage rules, etc.).

In one implementation, the MPOC smart PoS terminal 520 may obtain item information such as MCC code, item category code, purchase amount, price, and/or the like 507, and proceed to apply MPOC rules for account usage. In one implementation, the MPOC may query whether there is an amount based usage rule 508. For example, if the user has specified that any purchase amount greater than a threshold should be charged on a specified card, the MPOC may proceed to account recommendation 528. In an alternative implementation, the MPOC merchant PoS terminal may send the purchase item information to the MPOC server to determine account recommendation 509.

In another implementation, the MPOC may retrieve item category related usage rules, and group purchase items into categories 510. For each item category 512, the MPOC may query for an applicable account as prescribed by a usage rule 515, e.g., healthcare products for FSA account, grocery items for food stamp, etc. If there is an account applicable for the item category, the MPOC may associate the account as a recommended account 516. Otherwise, the MPOC may proceed with the next item category 518 until completing with all purchase items in the transaction.

In one implementation, the MPOC may provide an account recommendation list 528 for the user to select, and/or confirm the recommended account to proceed with payment. In another implementation, the MPOC may automatically proceed to process the transaction with the recommended account 326.

FIG. 5B provides an example of MPOC processing healthcare products and grocery purchases during one transaction within embodiments of the MPOC. In one embodiment, the MPOC may parse the purchased item's merchant category code 551 to determine a type of the purchase 552. In further implementations, during a real-time checkout (e.g., a PoS checkout or online checkout, etc.), the MPOC 520 may determine the purchase type based on the GPS information, terminal ID, and/or the like. For example, the user's location at a physician's office may suggest a healthcare purchase, but a location at a grocery store may suggest food purchase, e.g., 553.

In one implementation, if the product code and/or terminal ID shows the purchased product comprises food, the MPOC may determine whether food voucher is enrolled in the wallet 554. If there is a food stamp account 561, the MPOC may put the food stamp/voucher account on top of a recommended account list 565.

In another implementation, if the product code and/or terminal ID shows a healthcare purchase, the MPOC may determine a recommended plan based on user specified rules. For example, if the user prefers to pay with FSA, the MPOC may determine whether there is FSA 555 enrolled in the wallet. If yes, the MPOC may send a balance inquiry 556 to the account issuer 570, which may verify the account credentials (e.g., a token, etc.) 557 and return the available balance 558. The MPOC may proceed to determine whether there is sufficient balance 560. If yes, the MPOC may put FSA on top of a recommended account list 563. If not, the MPOC, may recommend FSA with the remaining available balance 568. The MPOC may query for other enrolled restricted use accounts 566 in a similar manner.

In a further implementation, the MPOC may determine if there is user specified goods (e.g., as shown at the rules specified by the user in 442a in FIG. 4A, etc.), and may put user defined priority account at the top of the recommendation list 566.

In one implementation, the MPOC may generate a prioritized list of accounts 572 and presented to the user 573 in the wallet payment page, e.g., as illustrated in FIGS. 5C-5D.

FIGS. 5C-5D provides a dollar amount payment flow illustrating MPOC account recommendation within embodiments of the MPOC. In one implementation, a user may set up accounts and spending rules for the enrolled restricted use accounts, e.g., at 521 in FIG. 5B. For example, the MPOC rules may be illustrated in one example in the following table:

| | |
|---|---|
| Primary Account: | Flexible Spending Account (FSA) |
| Balance: | $500.00 |
| End Date: | Dec. 31, 2015 |
| Rules: | 1. Only use for medical item |
| | category |
| | 2. Use for purchases less than |
| | $100.00 until Oct. 01, 2015 |
| | 3. After Oct. 01, 2015, use available |
| | balance for all medical item |
| | category purchases. |
| Second Account: | Health Savings Account (HSA) |
| Balance: | $5000.00 |
| Rules: | 1. Use for medical item category |
| | 2. Use for purchases greater than |
| | 2000.00 |
| | 3. Use as tertiary fund for medical |
| | item category purchases |
| Third Account: | Revolving Line of Credit (LOC) |
| Credit Line: | $5000.00 |
| Rules: | 1. Use for any item category |
| | 2. Use for purchases greater than |
| | $100 but less than $2000.00 |
| | 3. Use as secondary account for |
| | medical purchase |

For example, as shown in FIG. 5C, if a user 502 goes to a primary care physician on Jun. 8, 2015, i.e., more than half a year to the end date to his FSA, and a medical bill indicates a co-pay amount of $50.00 (e.g., at 581), the user may enter $50.00 into the MPOC mobile application and indicate it is medical purchase. Upon verifying the eligibility of medical purchase, the MPOC 520 may retrieve applicable healthcare restricted use accounts, and determine the user has his FSA, HSA and LOC accounts enrolled 582. The MPOC may then update the balance information of each account with the account sponsors 570.

In one implementation, the MPOC may assess the rules in the above example, and provide a screen of options showing the remaining balances in the three accounts 584, e.g., ranked as FSA ($500.00), LOC($2900.00), HSA ($5000.00). In one implementation, the MPOC may list the available accounts in a prioritized order based on the spending rules, showing the balance of each account 585. It should be noted that although mobile user interface elements are depicted, web, desktop and other interfaces are contemplated for all the user interfaces throughout the disclosure. In this example, although LOC is the third account after the HSA, LOC is listed prior to HSA as the rule specifies LOC is applied as secondary account for medical purchase. In one implementation, the MPOC may put a default dollar amount as $50.00 (e.g., 586) for payment, or the user may change it by type a different amount.

For another example, as shown in FIG. 5D, if the user 502 goes to a physical therapist at Sep. 27, 2015, i.e., approximately three months to the end date of FSA, and the patient's responsibility is $100.00, the user may enter $100.00 into the MPOC mobile component and confirm it is medical purchase 587. In FIG. 5D, the user may press a “pay” button and enter an amount and type of purchase 593. The MPOC 520 may retrieve applicable healthcare restricted use accounts, and determine the user has his FSA, HSA and LOC accounts enrolled 588. The MPOC may then update the balance information of each account with the account sponsors 589, responded by listing the remaining balances, e.g., FSA ($75.00), LOC ($3200.00), and HSA ($5000.00), etc. Upon applying the usage rules 590, in this case, even if the FSA has insufficient funds, it is on top of the prioritized list because it will expire at the end of the year. As the remaining balance in FSA is insufficient to cover the amount due, the user may split the amount by selecting FSA to pay $75.00 591 and LOC to pay the remaining $100-%75=$25. For example, after paying $75.00 with FSA, the FSA account may have an updated balance of 0.00 592. The user may elect to pay the remaining $25.00 593 with the LOC account. The MPOC may send a report summary to the user including the updated remaining balance of the accounts after payment, and/or the like.

For another example, if the user received a surgery on Sep. 30, 2015, i.e., approximately three months to the end date of FSA, and received a medical bill of $2000.00, but the current accounts have available balances of LOC ($3000.00), FSA (0), HSA ($5000.00). In this case, the user may elect to select HSA for the payment.

In an example, a customer may swipe an MPOC card at a supermarket's PoS terminal to pay for groceries, may select electronic benefits transfer (EBT) on a graphical user interface of the PoS terminal to indicate that this is a SNAP transaction, and may enter a personal identification number (PIN) associated with the customer's SNAP account. The PoS terminal may generate a processing code to indicate that the transaction is a SNAP transaction and a payment request message including the processing code, the unique identifier (e.g., a food and nutrition service (FNS) number of the merchant), the common account number read from the MPOC card, and one or more codes for the one or more products to be purchased.

The MPOC server determines how to route this transaction to a restricted-use issuer processor based on the processing code and the FNS number. For example, the MPOC server may presume that the customer has selected the appropriate restricted-use account at the merchant's PoS terminal. The MPOC server may then process the FNS number to confirm that the merchant has registered to be a provider under the terms of the SNAP program. For instance, the merchant may enroll with the SNAP account issuer processor to be an eligible SNAP provider and the issuer processor may assign the FNS number to the merchant. The merchant may provide the FNS number in each SNAP transaction so that the issuer processor can confirm that the merchant is an eligible SNAP provider. To confirm that the merchant is an eligible SNAP provider, the MPOC server may maintain a listing of unique identifiers for eligible merchants and/or may query the SNAP account issuer provider. If not eligible, the MPOC may respond to the PoS terminal with a message denying approval of the transaction.

If the merchant is an eligible provider, the MPOC may then retrieve routing information of the SNAP account issuer processor (as opposed to routing information for a TANF account issuer processor) and route the payment request message to the SNAP account issuer processor using the retrieved routing information. Subsequent to receipt, the SNAP account issuer processor may determine whether the cardholder has a balance remaining (e.g., in their monthly prescription) and send back a message to the merchant PoS terminal via the MPOC server either approving, declining or partially approving the transaction. If there was a partial approval the message may list the grocery items not approved and/or the approved grocery items. This example, as well as the other ones provided herein, may be conducted on a mobile device (e.g., a smart phone) instead of or in conjunction with a merchant's point of sale terminal. For instance, the mobile device may electronically communicate with the merchant's PoS terminal and/or with the MPOC server.

In another example, a customer may swipe an MPOC card at a supermarket's PoS terminal to pay for non-food items, and may select electronic benefits transfer (EBT) on a graphical user interface of the PoS terminal to indicate that this is a TANF transaction. The PoS terminal may generate a processing code to indicate that the transaction is a TANF transaction and a payment request message including the processing code, the unique identifier (e.g., a merchant qualification number), the common account number read from the MPOC card, and codes for the one or more non-food items to be purchased.

The MPOC server determines how to route this transaction to a restricted-use issuer processor based on the processing code and the unique identifier. For example, the MPOC server may presume that the customer has selected the appropriate restricted-use account at the merchant's PoS terminal. The MPOC server may then process the unique identifier to confirm that the merchant has registered to be a provider under the terms of the TANF program. For instance, the merchant enroll with the TANF account issuer processor to be an eligible TANF provider and the issuer processor may assign the unique identifier to the merchant. The merchant may provide the unique identifier in each TANF transaction so that the issuer processor can confirm that the merchant is an eligible TANF provider. To confirm that the merchant is an eligible TANF provider, the MPOC server may maintain a listing of unique identifiers for eligible merchants and/or may query the TANF account issuer provider. If not eligible, the MPOC may respond to the PoS terminal with a message denying approval of the transaction.

If the merchant is an eligible provider, the MPOC may then retrieve routing information of the TANF account issuer processor and route the payment request message to the TANF account issuer processor using the retrieved routing information. Subsequent to receipt, the TANF issuer processor may determine whether the cardholder has a balance remaining (e.g., in their monthly prescription) and send back a message to the merchant PoS terminal via the MPOC server either approving, declining or partially approving the transaction. If there was a partial approval the message lists of the non-food items not approved and/or the approved non-food items. Additionally or alternatively, the MPOC server may attempt to authorize the transaction on behalf of a government entity administering the TANF account (e.g., perform PIN verification, create a risk score, perform stand-in processing, perform token vault services and other processing services, etc.).

In yet another example, a customer may swipe an MPOC card at a supermarket's PoS terminal for an eWIC purchase, and may select electronic benefits transfer (EBT) on a graphical user interface of the PoS terminal to indicate that this is an eWIC transaction. The PoS terminal may generate a processing code to indicate that the transaction is an eWIC transaction and a payment request message including the processing code, the unique identifier (e.g., a merchant qualification number), the common account number read from the MPOC card, and codes for the products to be purchased.

The MPOC server determines how to route this transaction to a restricted-use issuer processor based on the processing code and the unique identifier. For example, the MPOC server may presume that the customer has selected the appropriate restricted-use account at the merchant's PoS terminal. The MPOC server may then process the unique identifier to confirm that the merchant has registered to be a provider under the terms of the eWIC program. For instance, the merchant enroll with the eWIC account issuer processor to be an eligible eWIC provider and the issuer processor may assign the unique identifier to the merchant. The merchant may provide the unique identifier in each eWIC transaction so that the issuer processor can confirm that the merchant is an eligible eWIC provider. To confirm that the merchant is an eligible eWIC provider, the MPOC server may maintain a listing of unique identifiers for eligible merchants and/or may query the eWIC account issuer provider. If not eligible, the MPOC may respond to the PoS terminal with a message denying approval of the transaction.

If the merchant is an eligible provider, the MPOC may then retrieve routing information of the eWIC account issuer processor and route the payment request message to the eWIC account issuer processor using the retrieved routing information. Subsequent to receipt, the eWIC issuer processor may determine whether the cardholder has a balance remaining (e.g., in their monthly prescription) and send back a message to the merchant PoS terminal via the MPOC server either approving, declining or partially approving the transaction. If there was a partial approval the message lists of the goods not approved and/or the approved goods. Additionally or alternatively, the MPOC server may perform the processing on behalf of the restricted-user issuer processor.

In a further example, a customer may swipe an MPOC card at a government approved medical clinic for a well-baby check-up, may select electronic benefits transfer (EBT) on a graphical user interface of the PoS terminal to indicate that this is a government approved medical transaction. The PoS terminal may generate a processing code to indicate that the transaction is a government approved medical expense and a payment request message including the processing code, the unique identifier (e.g., a merchant qualification number), the common account number read from the MPOC card, and one or more codes for the service to be provided.

The MPOC server determines how to route this transaction to a restricted-use issuer processor based on the processing code and the unique identifier. For example, the MPOC server may presume that the customer has selected the appropriate restricted-use account at the merchant's PoS terminal. The MPOC server may then process the unique identifier to confirm that the merchant has registered to be a provider under the terms of the government approved medical clinic program. For instance, the merchant enroll with the government approved medical clinic account issuer processor to be an eligible provider and the issuer processor may assign the unique identifier to the merchant. The merchant may provide the unique identifier in each medical transaction so that the issuer processor can confirm that the merchant is an eligible provider. To confirm that the merchant is an eligible eWIC provider, the MPOC server may maintain a listing of unique identifiers for eligible merchants and/or may query the eWIC account issuer provider. If not eligible, the MPOC may respond to the PoS terminal with a message denying approval of the transaction.

If the merchant is an eligible provider, the MPOC may then retrieve routing information of the government approved medical clinic account issuer processor and route the payment request message to the account issuer processor using the retrieved routing information. Subsequent to receipt, the government approved medical clinic issuer processor may determine whether the cardholder is eligible for the service and send back a message to the merchant PoS terminal via the MPOC server either approving or declining the transaction. Additionally or alternatively, the MPOC server may perform the processing on behalf of the restricted-user issuer processor.

In some instances, a customer may have transactions with one or more goods and/or services to be purchased using different accounts. In such an example, the PoS terminal may communicate multiple payment authorization request messages for each account, and/or may communicate a single multiple payment authorization request message having a processing code and unique identifier associated with each account. For example, a single multiple payment authorization request message may include a first processing code indicating that a part of a purchase transaction is associated with a SNAP account, a first unique identifier (e.g., FNS number) of the merchant, and one or more codes of products to be purchased using a SNAP account. The single request message may also include a second processing code that a part of a purchase transaction is associated with a TANF account, a second unique identifier of the merchant, and one or more codes of products to be purchased using a SNAP account. Upon receipt, the MPOC server may determine whether the merchant is an eligible SNAP provider and an eligible TANF provider. If not eligible for either, the MPOC server may return a message denial approval of the transaction. If only eligible for one, the MPOC server may return a message denial approval of that part of the transaction and may route the remainder to the appropriate issuer processor. If eligible for both, the MPOC server may route the portion of the transaction corresponding to the SNAP account to the SNAP account issuer processor and the portion of the transaction corresponding to the TANF account to the TANF account issuer processor. Each account issuer processor may approve, approve in part, or deny the transaction in the manner discussed above.

### MPOC Controller

FIG. 6 shows a block diagram illustrating example aspects of an MPOC controller 601. In this embodiment, the MPOC controller 601 may serve to aggregate, process, store, search, serve, identify, instruct, generate, match, and/or facilitate interactions with a computer through various technologies, and/or other related data.

Users, e.g., 633a, which may be people and/or other systems, may engage information technology systems (e.g., computers) to facilitate information processing. In turn, computers employ processors to process information; such processors 603 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 629 (e.g., registers, cache memory, random access memory, non-transitory computer readable medium, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the MPOC controller 601 may be connected to and/or communicate with entities such as, but not limited to: one or more users from user input devices 611; peripheral devices 612; an optional cryptographic processor device 628; and/or a communications network 613. For example, the MPOC controller 601 may be connected to and/or communicate with users, e.g., 633a, operating client device(s), e.g., 633b, including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™ Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s), and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.”There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The MPOC controller 601 may be based on computer systems that may comprise, but are not limited to, components such as: a computer systemization 602 connected to memory 629.

### Computer Systemization

A computer systemization 602 may comprise a clock 630, central processing unit (“CPU(s)” and/or “processor(s)” (these terms are used interchangeably throughout the disclosure unless noted to the contrary)) 603, a memory 629 (e.g., a read only memory (ROM) 606, a random access memory (RAM) 605, a non-transitory computer readable medium, etc.), and/or an interface bus 607, and most frequently, although not necessarily, are all interconnected and/or communicating through a system bus 604 on one or more (mother)board(s) 602 having conductive and/or otherwise transportive circuit pathways through which instructions (e.g., binary encoded signals) may travel to effectuate communications, operations, storage, etc. The computer systemization may be connected to a power source 686; e.g., optionally the power source may be internal. Optionally, a cryptographic processor 626 and/or transceivers (e.g., ICs) 674 may be connected to the system bus. In another embodiment, the cryptographic processor and/or transceivers may be connected as either internal and/or external peripheral devices 612 via the interface bus I/O. In turn, the transceivers may be connected to antenna(s) 675, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing MPOC controller to determine its location)); Broadcom BCM4329FKUBG transceiver chip (e.g., providing 802.11n, Bluetooth 2.1+EDR, FM, etc.), BCM28150 (HSPA+) and BCM2076 (Bluetooth 4.0, GPS, etc.); a Broadcom BCM4750IUB8 receiver chip (e.g., GPS); an Infineon Technologies X-Gold 618-PMB9800 (e.g., providing 2G/3G HSDPA/HSUPA communications); Intel's XMM 7160 (LTE & DC-HSPA), Qualcom's CDMA(2000), Mobile Data/Station Modem, Snapdragon; and/or the like. The system clock may have a crystal oscillator and generates a base signal through the computer systemization's circuit pathways. The clock may be coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: floating point units, integer processing units, integrated system (bus) controllers, logic operating units, memory management control units, etc., and even specialized processing sub-units like graphics processing units, digital signal processing units, and/or the like. Additionally, processors may include internal fast access addressable memory, and be capable of mapping and addressing memory 629 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state/value. The CPU may be a microprocessor such as: AMD's Athlon, Duron and/or Opteron; ARM's classic (e.g., ARM7/9/11), embedded (Coretx-M/R), application (Cortex-A), embedded and secure processors; IBM and/or Motorola's DragonBall and PowerPC; IBM's and Sony's Cell processor; Intel's Atom, Celeron (Mobile), Core (2/Duo/i3/i5/i7), Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code). Such instruction passing facilitates communication within the MPOC controller and beyond through various interfaces. Should processing requirements dictate a greater amount speed and/or capacity, distributed processors (e.g., Distributed MPOC), mainframe, multi-core, parallel, and/or super-computer architectures may similarly be employed. Alternatively, should deployment requirements dictate greater portability, smaller mobile devices (e.g., smartphones, Personal Digital Assistants (PDAs), etc.) may be employed.

Depending on the particular implementation, features of the MPOC may be achieved by implementing a microcontroller such as CAST's R8051XC2 microcontroller; Intel's MCS 51 (i.e., 8051 microcontroller); and/or the like. Also, to implement certain features of the MPOC, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the MPOC component collection (distributed or otherwise) and/or features may be implemented via the microprocessor and/or via embedded components; e.g., via ASIC, coprocessor, DSP, FPGA, and/or the like. Alternately, some implementations of the MPOC may be implemented with embedded components that are configured and used to achieve a variety of features or signal processing.

Depending on the particular implementation, the embedded components may include software solutions, hardware solutions, and/or some combination of both hardware/software solutions. For example, MPOC features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the MPOC features. A hierarchy of programmable interconnects allow logic blocks to be interconnected as needed by the MPOC system designer/administrator, somewhat like a one-chip programmable breadboard. An FPGA's logic blocks can be programmed to perform the operation of basic logic gates such as AND, and XOR, or more complex combinational operators such as decoders or simple mathematical operations. In most FPGAs, the logic blocks also include memory elements, which may be circuit flip-flops or more complete blocks of memory. In some circumstances, the MPOC may be developed on regular FPGAs and then migrated into a fixed version that more resembles ASIC implementations. Alternate or coordinating implementations may migrate MPOC controller features to a final ASIC instead of or in addition to FPGAs. Depending on the implementation all of the aforementioned embedded components and microprocessors may be considered the “CPU” and/or “processor” for the MPOC.

### Power Source

The power source 686 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 686 is connected to at least one of the interconnected subsequent components of the MPOC thereby providing an electric current to all the interconnected components. In one example, the power source 686 is connected to the system bus component 604. In an alternative embodiment, an outside power source 686 is provided through a connection across the I/O 608 interface. For example, a USB and/or IEEE 1394 connection carries both data and power across the connection and is therefore a suitable source of power.

### Interface Adapters

Interface bus(ses) 607 may accept, connect, and/or communicate to a number of interface adapters, frequently, although not necessarily in the form of adapter cards, such as but not limited to: input output interfaces (I/O) 608, storage interfaces 609, network interfaces 610, and/or the like. Optionally, cryptographic processor interfaces 627 similarly may be connected to the interface bus. The interface bus provides for the communications of interface adapters with one another as well as with other components of the computer systemization. Interface adapters are adapted for a compatible interface bus. Interface adapters may connect to the interface bus via expansion and/or slot architecture. Various expansion and/or slot architectures may be employed, such as, but not limited to: Accelerated Graphics Port (AGP), Card Bus, ExpressCard, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), Thunderbolt, and/or the like.

Storage interfaces 609 may accept, communicate, and/or connect to a number of storage devices such as, but not limited to: storage devices 614, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, Ethernet, fiber channel, Small Computer Systems Interface (SCSI), Thunderbolt, Universal Serial Bus (USB), and/or the like.

Network interfaces 610 may accept, communicate, and/or connect to a communications network 613. Through a communications network 613, the MPOC controller is accessible through remote clients 633b (e.g., computers with web browsers) by users 633a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed MPOC), architectures may similarly be employed to pool, load balance, and/or otherwise increase the communicative bandwidth required by the MPOC controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 610 may be used to engage with various communications network types 613. For example, multiple network interfaces may be employed to allow for the communication over broadcast, multicast, and/or unicast networks.

Input Output interfaces (I/O) 608 may accept, communicate, and/or connect to user input devices 611, peripheral devices 612, cryptographic processor devices 628, and/or the like. I/O may employ connection protocols such as, but not limited to: audio: analog, digital, monaural, RCA, stereo, and/or the like; data: Apple Desktop Bus (ADB), Bluetooth, IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, DisplayPort, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One output device may be a video display, which may take the form of a Cathode Ray Tube (CRT), Liquid Crystal Display (LCD), Light Emitting Diode (LED), Organic Light Emitting Diode (OLED), Plasma, and/or the like based monitor with an interface (e.g., VGA, DVI circuitry and cable) that accepts signals from a video interface. The video interface composites information generated by a computer systemization and generates video signals based on the composited information in a video memory frame. Another output device is a television set, which accepts signals from a video interface. Often, the video interface provides the composited video information through a video connection interface that accepts a video display interface (e.g., an RCA composite video connector accepting an RCA composite video cable; a DVI connector accepting a DVI display cable, HDMI, etc.).

User input devices 611 often are a type of peripheral device 612 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 612 may be connected and/or communicate to I/O and/or other facilities of the like such as network interfaces, storage interfaces, directly to the interface bus, system bus, the CPU, and/or the like. Peripheral devices may be external, internal and/or part of the MPOC controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 628), force-feedback devices (e.g., vibrating motors), near field communication (NFC) devices, network interfaces, printers, radio frequency identifiers (RFIDs), scanners, storage devices, transceivers (e.g., cellular, GPS, etc.), video devices (e.g., goggles, monitors, etc.), video sources, visors, and/or the like. Peripheral devices often include types of input devices (e.g., microphones, cameras, etc.).

It should be noted that although user input devices and peripheral devices may be employed, the MPOC controller may be embodied as an embedded, dedicated, and/or monitor-less (i.e., headless) device, wherein access would be provided over a network interface connection.

Cryptographic units such as, but not limited to, microcontrollers, processors 626, interfaces 627, and/or devices 628 may be attached, and/or communicate with the MPOC controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: the Broadcom's CryptoNetX and other Security Processors; nCipher's nShield (e.g., Solo, Connect, etc.), SafeNet's Luna PCI (e.g., 7100) series; Semaphore Communications' 40 MHz Roadrunner 184; sMIP's (e.g., 208956); Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 629. However, memory is a fungible technology and resource, thus, any number of memory embodiments may be employed in lieu of or in concert with one another. It is to be understood that the MPOC controller and/or a computer systemization may employ various forms of memory 6Error! Reference source not found.29. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In one configuration, memory 629 may include ROM 606, RAM 605, and a storage device 614. A storage device 614 may employ any number of computer storage devices/systems. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 629 may contain a collection of program and/or database components and/or data such as, but not limited to: operating system component(s) 615 (operating system); information server component(s) 616 (information server); user interface component(s) 617 (user interface); Web browser component(s) 618 (Web browser); database(s) 619; mail server component(s) 621; mail client component(s) 622; cryptographic server component(s) 620 (cryptographic server); the MPOC component(s) 635; and/or the like (i.e., collectively a component collection). These components may be stored and accessed from the storage devices and/or from storage devices accessible through an interface bus. Although non-conventional program components such as those in the component collection may be stored in a local storage device 614, they may also be loaded and/or stored in memory such as: peripheral devices, RAM, remote storage facilities through a communications network, ROM, various forms of memory, and/or the like.

### Operating System

The operating system component 615 is an executable program component facilitating the operation of the MPOC controller. The operating system may facilitate access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. In addition, emobile operating systems such as Apple's iOS, Google's Android, Hewlett Packard's WebOS, Microsoft Windows Mobile, and/or the like may be employed. Any of these operating systems may be embedded within the hardware of the NICK controller, and/or stored/loaded into memory/storage. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the MPOC controller to communicate with other entities through a communications network 613. Various communication protocols may be used by the MPOC controller as a subcarrier transport mechanism for interaction, such as, but not limited to: multicast, TCP/IP, UDP, unicast, and/or the like.

### Information Server

An information server component 616 is a stored program component that is executed by a CPU. The information server may be an Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Apple's iMessage, Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the MPOC controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the MPOC database 619, operating systems, other program components, user interfaces, Web browsers, and/or the like.

Access to the MPOC database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the MPOC. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the MPOC as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua and iOS's Cocoa Touch, IBM's OS/2, Google's Android Mobile UI, Microsoft's Windows 2000/2003/3.1/95/98/CE/Millenium/Mobile/NT/XP/Vista/7/8 (i.e., Aero, Metro), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 617 is a stored program component that is executed by a CPU. The user interface may be a graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 618 is a stored program component that is executed by a CPU. The Web browser may be a hypertext viewing application such as Google's (Mobile) Chrome, Microsoft Internet Explorer, Netscape Navigator, Apple's (Mobile) Safari, embedded web browser objects such as through Apple's Cocoa (Touch) object class, and/or the like. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., Chrome, FireFox, Internet Explorer, Safari Plug-in, and/or the like APIs), and/or the like. Web browsers and like information access tools may be integrated into PDAs, cellular telephones, smartphones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly effect the obtaining and the provision of information to users, user agents, and/or the like from the MPOC equipped nodes. The combined application may be nugatory on systems employing standard Web browsers.

### Mail Server

A mail server component 621 is a stored program component that is executed by a CPU 603. The mail server may be an Internet mail server such as, but not limited to Apple's Mail Server (3), dovect, sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the MPOC.

Access to the MPOC mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 622 is a stored program component that is executed by a CPU 603. The mail client may be a mail viewing application such as Apple (Mobile) Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 620 is a stored program component that is executed by a CPU 603, cryptographic processor 626, cryptographic processor interface 627, cryptographic processor device 628, and/or the like. Cryptographic processor interfaces will allow for expedition of encryption and/or decryption requests by the cryptographic component; however, the cryptographic component, alternatively, may run on a CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the MPOC may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the MPOC component to engage in secure transactions if so desired. The cryptographic component facilitates the secure accessing of resources on the MPOC and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The MPOC Database

The MPOC database component 619 may be embodied in a database and its stored data. The database is a stored program component, which is executed by the CPU; the stored program component portion configuring the CPU to process the stored data. The database may be any of a number of fault tolerant, relational, scalable, secure databases, such as DB2, MySQL, Oracle, Sybase, and/or the like. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the MPOC database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the MPOC database is implemented as a data-structure, the use of the MPOC database 619 may be integrated into another component such as the MPOC component 635. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 619 includes several tables 619a-q. A Users table 619a may include fields such as, but not limited to: user_id, applicant_id, firstname, lastname, address_line1, address_line2, dob, ssn, credit_check_flag, zipcode, city, state, account_params_list, account_mode, account_type, account_expiry, preferred_bank_name, preferred_branch_name, credit_report, and/or the like. The User table may support and/or track multiple entity accounts on a MPOC. A Clients table 619b may include fields such as, but not limited to: client_ID, client_type, client_MAC, client_IP, presentation_format, pixel_count, resolution, screen_size, audio_fidelity, hardware_settings_list, software_ compatibilities_list, installed_apps_list, and/or the like. An Apps table 619c may include fields such as, but not limited to: app_ID, app_name, app_type, OS_compatibilities_list, version, timestamp, developer_ID, and/or the like. An Accounts table 619d may include fields such as, but not limited to: user_id, account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, and/or the like. A Claims table 619e may include fields such as, but not limited to: user_id, claim_id, timestamp claim_type, snapshot_array, receipt_data, process_sent_flag, process_clear_flag, and/or the like. An Issuers table 619f may include fields such as, but not limited to: account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, issuer_id, issuer_name, issuer_address, ip_address, mac_address, auth_key, port_num, security_settings_list, and/or the like. A Merchants table 619g may include fields such as, but not limited to: merchant_id, merchant_name, provi merchant_address, ip_address, mac_address, auth_key, port_num, security_settings_list, and/or the like. An Acquirers table 619h may include fields such as, but not limited to: account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, and/or the like. A Transactions table 619i may include fields such as, but not limited to: order_id, user_id, timestamp, transaction_cost, purchase_details_list, num_products, products_list, product_type, product_params_list, product_title, product_summary, quantity, user_id, client_id, client_ip, client_type, client_model, operating_system, os_version, app_installed_flag, user_id, account_firstname, account_lastname, account_type, account_num, billingaddress_line1, billingaddress_line2, billing_zipcode, billing_state, shipping_preferences, shippingaddress_line1, shippingaddress_line2, shipping_zipcode, shipping_state, merchant_id, merchant_name, merchant_auth_key, rebate_ID, rebate_amount, rebate_user, rebate_sponsor, social_payment_id, and/or the like. A Batches table 619j may include fields such as, but not limited to: applicant_firstname, applicant_lastname, applicant_address_line1, applicant_address_line2, consumer_bureau_data_list, consumer_bureau_data, applicant_clear_flag, credit_limit, credit_score, account_balances, delinquency_flag, quality_flags, batch_id, transaction_id_list, timestamp_list, cleared_flag_list, clearance_trigger_settings, and/or the like. A Ledgers table 619k may include fields such as, but not limited to: request_id, timestamp, deposit_amount, batch_id, transaction_id, clear_flag, deposit_account, transaction_summary, payor_name, payor_account, and/or the like. An Insurance Provider table 619l may include fields such as, but not limited to InsuranceID, InsuranceName, InsuranceProgram, InsuranceBIN, InsuranceCoverageTable, InsuranceVeriCode, InsuranceAuthorization, and/or the like. A Healthcare Provider table 619m may include fields such as, but not limited to Health ProviderID, Health ProviderName, Health ProviderZipcode, HealthProviderProcedureCode, HealthProviderClaimCode, Health ProviderPricingList, and/or the like. A medical products/services table 619n may include fields such as, but not limited to authorizedMedProductID, authorizedMedServiceID, ProductCode, ServiceProcedureCode, HealthProviderID, InsuranceID, InsuranceCoverageRate, PricingRate, and/or the like. A Restricted-Use Codes table 6190 may include fields such as, but not limited to ru_type, ru_issuer, ru_category, ru_mcc, ru_sponsor, ru_rule, ru_deduction, ru_alert, ru_account, ru_whitelist, ru_blacklist, and/or the like. A Receipt table 619p may include fields such as, but not limited to receipt_id, receipt_user_id, receipt_wallet_id, receipt_time, receipt_merchant_id, receipt_image, receipt_item, receipt_mcc, receipt_amount, receipt_transaction_id, receipt_transaction_amount, receipt_claim, receipt_qr_code, receipt_item_ru, and/or the like. A Bill table 619q may include fields such as, but not limited to bill_id, bill_user_id, bill_wallet_id, bill_time, bill_merchant_id, bill_image, bill_item, bill_mcc, bill_amount, bill_transaction_id, bill_transaction_amount, bill_claim, bill_qr_code, bill_item_ru, and/or the like.

In one embodiment, the MPOC database may interact with other database systems. For example, employing a distributed database system, queries and data access by search MPOC component may treat the combination of the MPOC database, an integrated data security layer database as a single database entity.

In one embodiment, user programs may contain various user interface primitives, which may serve to update the MPOC. Also, various accounts may require custom database tables depending upon the environments and the types of clients the MPOC may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 619a-q. The MPOC may be configured to keep track of various settings, inputs, and parameters via database controllers.

The MPOC database may communicate to and/or with other components in a component collection, including itself, and/or facilities of the like. Most frequently, the MPOC database communicates with the MPOC component, other program components, and/or the like. The database may contain, retain, and provide information regarding other nodes and data.

### The MPOCs

The MPOC component 635 is a stored program component that is executed by a CPU. In one embodiment, the MPOC component incorporates any and/or all combinations of the aspects of the MPOC discussed in the previous figures. As such, the MPOC affects accessing, obtaining and the provision of information, services, transactions, and/or the like across various communications networks. The features and embodiments of the MPOC discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the MPOC's features and facilities, and in many cases reduce the costs, energy consumption/requirements, and extend the life of MPOC's underlying infrastructure; this has the added benefit of making the MPOC more reliable. Similarly, many of the features and mechanisms are designed to be easier for users to use and access, thereby broadening the audience that may enjoy/employ and exploit the feature sets of the MPOC; such ease of use also helps to increase the reliability of the MPOC. In addition, the feature sets include heightened security as noted via the Cryptographic components 620, 626, 628 and throughout, making access to the features and data more reliable and secure.

The MPOC transforms purchase item information inputs (e.g., see 203 in FIG. 2A) via MPOC components such as consumer enrollment component 642 (e.g., FIG. 6), card processing component 643, account recommendation component 645 (e.g., see FIG. 6), funds allocation component 647 (e.g., see FIG. 6), and/or the like into account payment settlement outputs (e.g., see 226 in FIG. 2A, and/or the like).

The MPOC component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the MPOC server employs a cryptographic server to encrypt and decrypt communications. The MPOC component may communicate to and/or with other components in a component collection, including itself, and/or facilities of the like. Most frequently, the MPOC component communicates with the MPOC database, operating systems, other program components, and/or the like. The MPOC may contain, communicate, generate, obtain, and/or provide program component, system, user, and/or data communications, requests, and/or responses.

### Distributed MPOCs

The structure and/or operation of any of the MPOC node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the MPOC controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the MPOC controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header(′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {

$input = “”;
$input = socket_read($client, 1024);
$data .= $input;

} while($input != “”);
// parse data to extract variables
$obj = json_decode($data, true);
// store input data in a database
mysql_connect(″201. 408. 185.132″,$DBserver,$password); // access

database server

mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/com.ibm.IB

MDI.doc/referenceguide295.htm

and other parser implementations:

http://publib.boulder.ibm.com/infocenter/tivihelp/v2r1/index.jsp?topic=/com.ibm.IB

MDI.doc/referenceguide259.htm

all of which are hereby expressly incorporated by reference herein.

In order to address various issues and advance the art, the entirety of this application for MPOC APPARATUSES, METHODS AND SYSTEMS (including the Cover Page, Title, Headings, Field, Background, Summary, Brief Description of the Drawings, Detailed Description, Claims, Abstract, Figures, Appendices and/or otherwise) shows by way of illustration various example embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any data flow sequence(s), program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, processors, services, servers, and/or the like that may execute asynchronously, concurrently, in parallel, simultaneously, synchronously, and/or the like are also contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations, including the right to claim such innovations, file additional applications, continuations, continuations-in-part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a MPOC individual and/or enterprise user, database configuration and/or relational model, data type, data transmission and/or network framework, syntax structure, and/or the like, various embodiments of the MPOC may be implemented that allow a great deal of flexibility and customization. For example, aspects of the MPOC may be adapted for various employer benefits. While various embodiments and discussions of the MPOC have been directed to prepaid card transactions, however, it is to be understood that the embodiments described herein may be readily configured and/or customized for a wide variety of other applications and/or implementations.

What is claimed is:

1. A processor-implemented payment method comprising:
receiving a payment authorization request message at a financial transaction processing server associated with a purchase transaction, wherein the payment authorization request message is in compliance with a transaction processing format;
processing, by the processing server, the payment authorization request message to obtain a value from a field that indicates an account type identified by user input and a unique identifier associated with a merchant;
processing, by the processing server, the account type to determine which of a restricted-use account and a non-restricted use account has been identified as a source of funds for the payment transaction;
in response to determining that the restricted-use account has been identified as the source of funds, processing the unique identifier to determine that the merchant is an eligible provider of a good or service associated with the restricted-use account;
in response to determining that the merchant is an eligible provider, identifying routing information of an issuer processor associated with the restricted-use account; and
routing, using the identified routing information, the payment authorization request message to the identified issuer processor for processing of the payment authorization request message.

2. The method of claim 1, wherein the unique identifier is a merchant qualification number assigned to the merchant by the identified issuer processor to indicate that the merchant is eligible to provide a product or service and to charge the restricted-use account.

3. The method of claim 1, further comprising:
obtaining purchase item category information from the payment authorization request message; and
verifying the purchase item qualifies for usage of the consumer payment account.

4. The method of claim 1, wherein the restricted-use account is a supplemental nutrition assistance program account, a temporary assistance to needy families account, a health savings account, a health reimbursement account, a flexible spending account, or a government assistance account.

5. The method of claim 1, wherein the payment authorization request message comprises a common account number that is associated with the restricted-use account and the non-restricted-use account.

6. The method of claim 1, wherein the payment authorization request message comprises a common account number that is associated with the restricted-use account and at least one other restricted-use account.

7. The method of claim 1, wherein the payment authorization request message comprises a code identifying a product or service requested to be purchased.

8. The method of claim 1, further comprising:
receiving a payment issuer response from the identified issuer; and
routing the payment issuer response to approve, deny, or partially approve the purchase transaction.

9. An apparatus comprising:
means for receiving a payment authorization request message associated with a purchase transaction, wherein the payment authorization request message is in compliance with a transaction processing format;
means for processing the payment authorization request message to obtain a value from a field that indicates an account type identified by user input and a unique identifier associated with a merchant;
means for processing the account type to determine which of a restricted-use account and a non-restricted use account has been identified as a source of funds for the payment transaction;
in response to determining that the restricted-use account has been identified as the source of funds, means for processing the unique identifier to determine that the merchant is an eligible provider of a good or service associated with the restricted-use account;
in response to determining that the merchant is an eligible provider, means for identifying routing information of an issuer processor associated with the restricted-use account; and
means for routing, using the identified routing information, the payment authorization request message to the identified issuer processor for processing of the payment authorization request message.

10. The apparatus of claim 9, wherein the unique identifier is a merchant qualification number assigned to the merchant by the identified issuer processor to indicate that the merchant is eligible to provide a product or service and to charge the restricted-use account.

11. The apparatus of claim 9, further comprising:
means for obtaining purchase item category information from the payment authorization request message; and
means for verifying the purchase item qualifies for usage of the consumer payment account.

12. The apparatus of claim 9, wherein the payment authorization request message comprises a common account number that is associated with the restricted-use account and the non-restricted-use account.

13. The apparatus of claim 9, wherein the payment authorization request message comprises a common account number that is associated with the restricted-use account and at least one other restricted-use account.

14. The apparatus of claim 9, further comprising:
means for receiving a payment issuer response from the identified issuer; and
means for routing the payment issuer response to approve, deny, or partially approve the purchase transaction.

15. A computer readable medium storing instructions that, when executed, cause an apparatus at least to perform:
receiving a payment authorization request message associated with a purchase transaction, wherein the payment authorization request message is in compliance with a transaction processing format;
processing the payment authorization request message to obtain a value from a field that indicates an account type identified by user input and a unique identifier associated with a merchant;
processing the account type to determine which of a restricted-use account and a non-restricted use account has been identified as a source of funds for the payment transaction;
in response to determining that the restricted-use account has been identified as the source of funds, processing the unique identifier to determine that the merchant is an eligible provider of a good or service associated with the restricted-use account;
in response to determining that the merchant is an eligible provider, identifying routing information of an issuer processor associated with the restricted-use account; and
routing, using the identified routing information, the payment authorization request message to the identified issuer processor for processing of the payment authorization request message.

16. The computer readable medium of claim 15, wherein the unique identifier is a merchant qualification number assigned to the merchant by the identified issuer processor to indicate that the merchant is eligible to provide a product or service and to charge the restricted-use account.

17. The computer readable medium of claim 15, wherein the instructions, when executed, further cause the apparatus at least to perform:
obtaining purchase item category information from the payment authorization request message; and
verifying the purchase item qualifies for usage of the consumer payment account.

18. The computer readable medium of claim 15, wherein the payment authorization request message comprises a common account number that is associated with the restricted-use account and the non-restricted-use account.

19. The computer readable medium of claim 15, wherein the payment authorization request message comprises a common account number that is associated with the restricted-use account and at least one other restricted-use account.

20. The computer readable medium of claim 15, wherein the instructions, when executed, further cause the apparatus at least to perform:
receiving a payment issuer response from the identified issuer; and
routing the payment issuer response to approve, deny, or partially approve the purchase transaction.
